(19) United States
(12) Patent Application Publication
(10) Pub. No.: US 2014/0083058 A1
(43) Pub. Date: Mar. 27, 2014

(54) CONTROLLING AND MONITORING OF A STORAGE AND ORDER-PICKING SYSTEM BY MEANS OF MOTION AND SPEECH

(71) Applicant: SSI Schaefer Noell GmbH Lager-und Systemtechnik, Giebelstadt (DE)

(72) Inventors: Elmar Issing, Giebelstadt (DE); Rudolf Keller, Wollerau (CH)

(21) Appl. No.: 14/028,727

(22) Filed: Sep. 17, 2013

Related U.S. Application Data
(63) Continuation of application No. PCT/EP2011/054087, filed on Mar. 17, 2011.

(51) Int. Cl. B65B 35/30; G09B 7/02

(52) U.S. Cl. CPC B65B 35/30; G09B 7/02
USPC 53/473; 434/219; 53/52

(57) ABSTRACT

Storage and order-picking system for storing and picking piece goods, comprising: a manual work station comprising a defined working area, in which an operator is supposed to manipulate a piece good with his/her hands in a default manner, which is communicated to the operator visually and/or audibly, in that the operator moves the piece good within the working area; a motion-sensor system, which detects motions, preferably of the hands and/or forearms, of the operator within the working area of the work station and which converts same into corresponding motion signals; and a computing unit, which is data connected to the motion-sensor system and which is configured to convert the motion signals into corresponding, preferably time-dependent, trajectories in a virtual space, which is an image of the working area and where the trajectories are compared to reference trajectories, or reference volumina, in the virtual space, in order to generate and output control signals which indicate a correct or wrong performance of the default manipulation manner to the operator.

### RELATED APPLICATIONS

This is a continuation application of the co-pending international application WO 2012/123033 A1 (PCT/EP2011/054087) filed on Mar. 17, 2011 which is fully incorporated herewith by reference.

### BACKGROUND OF THE INVENTION

The present invention relates to a storage and order-picking system which is equipped with a motion-sensor system which allows to draw conclusions on a correct conduction of manipulation processes by means of measurement of motions of an operator, wherein piece goods are manually manipulated. Further, piece goods can be measured by using the hands only, i.e. without additional aids. Finally, control instructions, which cause movements within the storage and order-picking system, can be generated, or triggered, by means of specific gestures of the operator only.

### RELATED PRIOR ART

In the field of intralogistics substantially two principles exist according to which goods are moved within a warehouse. The order-picking process either happens in accordance with the principle “man-to-goods” or in accordance with the principle “goods-to-man”. Additionally, a plurality of different order-picking systems, or order-picking guidance systems, exist which are designated by terms such as “Pick-to-Belt” or “Pick-by-Light” or the like.

Timm Gudehus describes in his book “Logistics” (Springer-Verlag, 2004, ISBN 3-540-00606-0) the term “Pick-to-Belt” as an order-picking method, wherein the picking happens in a decentralized manner wherein the articles are provided statically. Provision units (such as storage containers or piece goods) have a fixed location, if picking happens in a decentralized manner. An order-picking person moves within a (decentralized) working area for the purpose of picking, the working area containing a certain number of access locations. Picking orders, with or without collecting containers, sequentially travel to corresponding order-picking zones (working area of the order-picking person) on a conveyor system. An order, or a picking order, is to be understood, for example, as a customer's order which includes one or more order positions (order lines) including a respective amount (removal quantity) of one article or one piece good. The orders stop in the order-picking zone until required article amounts are removed and deposited. Then, the order can travel, if necessary, to a subsequent order-picking person, who operates an order-picking zone, which is arranged downstream, for processing next order lines. Advantages of the decentralized picking process are: short paths and continuous operation; no set-up times and waiting times at a central basis; as well as a higher picking performance of the order-picking persons. Therefore, “batch picking” is often conducted with “Pick-to-Belt” applications, i.e. as much as possible customers orders, which contain a specific article type, are concatenated so that the order-picking person removes this article type for all of the customer orders. This reduces the walking path of the order-picking person.

Another order-picking method is designated as “Pick-by-Light” (source: Wikipedia). Pick-by-Light offers significant advantages in comparison to classic manual order-picking methods which require the presence of delivery notes or debit notes at the time of the order-picking process. With Pick-by-Light systems a signal lamp including a digital or alphanumeric display as well as at least one acknowledgement key and, if necessary, entry and correction keys are located at each of the access locations. If the order container, into which the articles are to be deposited, for example, from storage containers, arrives at an order-picking position, then the signal lamp of the access location is lit from which the articles or piece goods are to be removed. The number, which is to be removed, appears on the display. Then, the removal is confirmed by means of the acknowledgement key, and the inventory change can be reported back to the warehouse management system in real time. In most cases the Pick-by-Light systems are operated in accordance with the principle “man-to-goods”.

Further, paperless order-picking by means of “Pick-by-Voice” is known (source: Wikipedia). In this case communication between a data processing system and the order-picking system happens via voice. Most of the time the order-picking person works with a headset (earphone and microphone), which can be connected, for example, to a commercially available pocket PC, instead of using printed order-picking lists or data radio terminals (i.e. mobile data acquisition units, MDU). The orders are radio transmitted by the warehouse management system, most of the time by means of WLAN/WiFi, to the order-picking person. Typically, a first voice output includes the rack from which piece goods are to be removed. If the order-picking person has arrived at the rack, he/she can name a check digit attached to the rack, which allows the system to check the access location. If the correct check digit has been named, a removal quantity in terms of a second voice output is named to the order-picking person. If the rack comprises several access locations, as a matter of course the order-picking person is named the specific access location in terms of a voice output as well. After removal of the to-be-picked piece good, or of the to-be-picked piece goods, the order-picking person acknowledges this process by means of key words which are understood by a data processing device due to voice recognition.

In the house of the applicant coordination of the processing of orders is conducted by an order processing system, the order processing system being integrated most of the time into an order-picking control, which can also comprise, for example, a material management system. Further, a (warehouse) location management as well as an information-display system can be integrated into the order-picking control. The order-picking control is typically realized by a data processing system which preferably works online for transmitting data without delay and for processing data. One problem of the above-mentioned conventional order-picking methods is to be seen in the manner of how the order-picking person—i.e. the operator of a work station—communicates with the order-picking control. Another problem is to be seen in the checking and monitoring of the operator.

Often an order-picking process consists of a plurality of sequential operation and manipulation steps, wherein the piece goods are picked, for example, at a source location and delivered to a target location. It is not clear whether the operator accesses the right source location and delivers to the right target location, and therefore needs to be monitored (e.g. by means of light barriers). Further, deviations can occur between a number of to-be-manipulated piece goods and a number of actually manipulated piece goods. Therefore, also the number of manipulated piece goods is to be monitored.

In order to begin a manipulation, the operator needs to communicate with the order-picking control. The same applies with regard to indication of an end of a manipulation. Frequently the above already mentioned acknowledgement keys are used for this purpose. One disadvantage of the acknowledgement keys is to be seen in that they are arranged stationary and that the operator needs to walk to the acknowledgement keys in order to actuate the same. This requires time. The more time is needed for each manipulation, the lower the picking performance (number of manipulations per unit of time) is.

The document U.S. Pat. No. 6,324,296 B1 discloses a distributed-processing motion capture system (and inherent method) comprising: plural light point devices, e.g., infrared LEDs, in a motion capture environment, each providing a unique sequence of light pulses representing a unique identity (ID) of a light point device; a first imaging device for imaging light along a first and second axis; and a second imaging device for imaging light along a third and fourth axis. Both of the imaging devices filter out information not corresponding to the light point devices, and output one-dimensional information that includes the ID of a light point device and a position of the light point device along one of the respective axes. The system also includes a processing device for triangulating three-dimensional positions of the light point devices based upon the one-dimensional information. The system is very fast because the necessary processing is distributed to be maximally parallel. The motion capture system uses a cylindrical collimating (CC) optics sub-system superimposed on a cylindrical telecentric (CT) optics sub-system. The outputs of the plural light point devices are modulated to provide a unique sequence of light pulses representing a unique identifier (ID) for each of the light point devices according to a predetermined cycle of modulation intervals based upon synchronization signals provided via RF communication. At least two of the light point devices concurrently provide light during the cycle.

The document U.S. Pat. No. 6,724,930 B1 discloses a three-dimensional position and orientation sensing apparatus including: an image input section which inputs an image acquired by an image acquisition apparatus and showing at least three markers having color or geometric characteristics as one image, three-dimensional positional information of the markers with respect to an object to be measured being known in advance; a region extracting section which extracts a region corresponding to each marker in the image; a marker identifying section which identifies the individual markers based on the color or geometric characteristics of the markers in the extracted regions; and a position and orientation calculating section which calculates the three-dimensional position and orientation of the object to be measured with respect to the image acquisition apparatus, by using positions of the identified markers in the image input to the image input section, and the positional information of the markers with respect to the object to be measured.

The document WO 2011/013079 A1 discloses a method for depth mapping includes projecting a pattern of optical radiation onto an object. A first image of the pattern on the object is captured using a first image sensor, and this image is processed to generate pattern-based depth data with respect to the object. A second image of the object is captured using a second image sensor, and the second image is processed together with another image to generate stereoscopic depth data with respect to the object. The pattern-based depth data is combined with the stereoscopic depth data to create a depth map of the object.

### SUMMARY OF THE INVENTION

Therefore, it is an object to monitor the manipulations better and to facilitate the communication between the operator and the order-picking control, in particular if guidance of the operator with regard to the order-picking process is concerned.

According to a first aspect of the invention it is disclosed a storage and order-picking system for storing and picking piece goods comprising: a manual work station comprising a defined working area, in which an operator is supposed to manipulate a piece good with his/her hands in a default manner, which is communicated to the operator visually and/or audibly, in that the operator moves the piece good within the working area; a motion-sensor system, which detects motions, preferably of the hands and/or forearms, of the operator within the working area of the work station and which converts same into corresponding motion signals; and a computing unit, which is data connected to the motion-sensor system and which is configured to convert the motion signals into corresponding, preferably time-dependent, trajectories in a virtual space, which is an image of the working area and where the trajectories are compared to reference trajectories, or reference volumina, in the virtual space, in order to generate and output control signals which indicate a correct or wrong performance of the default manipulation manner to the operator.

According to a second aspect of the invention it is disclosed a storage and order-picking system for storing and picking piece goods, comprising: a manually operated work station arranged in a fixed working area, in which an operator manipulates the piece goods with his/her hands in a default manipulation manner, which is communicated to the operator visually, or audibly, wherein the operator moves the piece goods within the working area; a motion-sensor system configured to detect the operators's motions within the working area of the work station, and to convert same into corresponding motion signals; and a computing unit, which is connected to the motion-sensor system and which is configured to convert the motion signals into corresponding trajectories in a virtual space, which represents an image of the working area in real space, wherein the converted trajectories are compared to reference trajectories, or reference volumina, in the virtual space, which is modeled in accordance with the real space as a reference model, the computing unit being further configured to generate and output control signals, based on the comparison, which indicate a correct or wrong performance of the default manipulation manner to the operator.

The invention tracks the operator's motion during an order-picking process, preferably in real time. If the operator gets a piece good from a wrong location, this can be recognized in the virtual world (3D reference model) of the work station immediately by comparison of a calculated position with a reference position. Of course, the same applies to the delivery and, if necessary, also to the movement of the piece good between the pick-up and the delivery. For example, it might happen that the piece good is to be rotated about a specific angle during the pick-up and the delivery, in order to be orientated better on an order pallet for subsequent stacking purposes. Modern packing software definitely considers such movements during the planning of a loading configuration.

It is clear that hereinafter a trajectory is not only to be understood as a time-dependent curve in space, which is typically caused by a (dynamic) motion of the operator, but the term “trajectory” can also include freezing at one location. In this case the trajectory does not represent a track extending through the space but represents the course of one point within a very very little volume. Ideally, the point does not move in this case. In general, a “trajectory”, in terms of an object tracking, is a time sequence of (3D) coordinates which represent a motion path of the object during a run time.

With a preferred embodiment the storage and order-picking system comprises a goods receipt, a goods issue, at least one warehouse, and/or a conveyor system.

The invention can be used in each area of a storage and order-picking system and is not limited to specific locations, or areas.

In particular, the work station can be a packing station, an order-picking station, or a teach-in station (station for measuring piece goods), which preferably is operated in accordance with the principle “goods-to-man”.

With preferred embodiment the motion-sensor system comprises a position-determining system, which at least comprises one camera and at least two light sources, wherein the at least two light sources are arranged at a fixed distance to each other, wherein respectively the camera or the two light sources are attached, preferably in parallel to the ell or stretched index finger, to the hands or forearms of the operator, and wherein the calculating unit is configured to perform, based on an image of the two light sources which is recorded by the camera, an absolute position determination of the hands and/or forearms within the working area.

The (absolute) position determination presently takes place in the so-called pointer mode. The light sources and the camera are orientated to each other and can “see” each other. The position determination happens in terms of triangulation, wherein the distance of the light sources relative to each other is already known in advance. In this context it is irrelevant whether the light sources rest and the camera moves, or whether the camera rests and the light sources move.

Further, it is preferred if the at least one camera or the at least two light sources are respectively attached to a holding device, which preferably is flexible and formed such that the operator can wear the holding device during the performance of the manipulation of piece goods permanently, captively, and in a manner which allows to keep a fixed orientation. The above-mentioned position-determining system, or parts thereof, are to be attached to the operator in a preset orientation. The attachment happens, for example, by means of a glove, an arm gaiter, or the like such as rubber ribbons or elastic rings. The index finger and the ell are predestined for the attachment and orientation. A stretched index finger is typically orientated in parallel to the ell, if an extended arm points to an object.

As mentioned above in particular a glove, an arm gaiter, or a plurality of, preferably elastic, ribbons or rings are used as the holding device.

Further, it is advantageous to provide the motion-sensor system additionally with at least two motion sensors, which are orientated along different spatial directions and which generate the direction-dependent (motion and position) information, which can be transmitted to the calculating device, wherein the calculating device is configured to conduct a relative position determination of the operator within the working area based on the direction-dependent information.

Both translatory motions and rotatory motions can be detected by means of the motion sensors. If three motion sensors are provided, which are orientated along vectors which in turn span the space of the working area, each position change can be determined by calculation. If the system has been calibrated additionally in advance, by conducting an absolute position determination, then an absolute position can also be calculated over longer periods.

Therefore, motion sensors are ideally suitable for being combined with the above-mentioned position-determining system, which however is only operable in the pointing mode without additional technical aid. If the pointing mode is quit, the position determination can be continued—by calculation—based on the data delivered by the motion sensors.

Additionally, it is advantageous if the motion-sensor system comprises a position-determining system which comprises at least one stationary light source and at least one stationary camera, wherein each of the light sources illuminates the working area, wherein the at least one stationary camera is arranged such that at least some rays are detected, which are reflected by the operator and which are converted into reflection signals by the at least one stationary camera, wherein the calculating device is configured to conduct a relative position determination of the operator within the working area based on the reflection signals.

In this case, the invention utilizes the so-called “Motion Capturing Method”. Points which can be additionally marked by markers are permanently illuminated and reflections thereof are detected, in order to allow reconstruction of the motion of the points in space by calculation. This coarse position determination, which is typically slightly delayed in time, is sufficient for many applications in the field of intralogistics, in order to check approximately the quality (correctness) of the order-picking process, and to initiate correction measures, if necessary.

With another preferred embodiment the position determining system comprises additional markers, wherein preferably each hand and/or each forearm of the operator is connected to one of the markers in an unchangeable preset orientation relative to the operator, and wherein the at least one stationary light source emits (isotopic) rays at a selected wavelength into the working area, which are not reflected at all, or only weakly, by the operator, the piece goods, and the work station, wherein the marker is made of a material which reflects the selected wavelength particularly well.

Thus, the operator does not necessarily need to be equipped with a marker, which actively transmits, in order to allow gain of information on the position of the operator. Since the markers substantially reflect the rays of the stationary light source, time consuming post-processing of the data and expensive filters for suppressing undesired signals can be omitted.

Besides this, the markers can be longitudinal flexible stripes which are attachable along an ell, a thumb, or an index finger of the operator, or can be points attachable along a grid.

With another advantageous embodiment the stationary light source of the position-determining system transmits a plurality of separate rays in a predefined discrete pattern (anisotropically) into the working area, wherein at least two stationary cameras are provided, which are arranged in common with the at least one stationary light source along a straight line so that the at least two stationary cameras detect at least some of the separate rays reflected by the operator and convert the same into reflection signals, wherein the calculating unit is configured to conduct a relative position determination of the hands and/or forearms within the working area based on the reflection signals.

In the present case, again a passive system is described, in which the operator merely serves as a reflector. In this case it is not even necessarily required that the operator is equipped with corresponding markers. Since the light source emits a regular pattern, consisting of discrete rays, depth information on the reflecting object (operator) can already be achieved alone by means of one single camera. Due to the fact that two cameras are arranged at same height relative to the light source, further the principles of stereoscopy can be used for attracting additional depth information. In addition, it is possible to conduct a relative position determination on the object, which moves within the illuminated field of view of the light source and thus also reflects radiation. The system can be calibrated in advance, in order to allow calculation of an absolute position. In this context, it is an advantage that the operator does not need to be provided with markers or the like, wherein information on a current position can be determined nevertheless. In any case, the operator can work in an undisturbed manner.

Further, it is advantageous if the at least two stationary cameras are operated in different frequency ranges, preferably in the infrared range and in the visible spectrum.

Infrared light does not disturb the operator during work. An RGB camera, which records visible light, can be used additionally for generating a normal video image besides the gain of depth information.

With another particular embodiment the system comprises a display device, which receives the control signals of the calculating unit and which communicates to the operator a manipulation manner recognized as being right or wrong.

In this manner it is possible to immediately intervene if an error is recognized. The operator can even be prevented from terminating an erroneous manipulation step. In this case the error does not happen at all. When carried out properly this can be communicated to the operator in a timely manner in terms of positive feedback.

Preferably, the system further comprises a video camera generating a real image of the working area, wherein the calculating unit is configured to generate image signals in real time and to transmit the same to the display device, which superimposes to the real image a reference source volume, a reference target volume as well as the recognized hands and/or forearms of the operator, and/or work instructions.

If such a video image is displayed to the operator, while the desired manipulation is conducted within the working area, the operator can immediately recognize whether the desired manipulation is correctly conducted and what needs to be done. If piece goods are taken, the operator can see on the screen whether the piece goods are taken from the correct location, because the correct location needs to be located within the source volume, which is displayed in a superimposed manner. The same applies analogously during delivery, since the target volume is displayed in a superimposed manner. If a tilt or rotation or the piece good is to be conducted additionally on the path between the pick-up and the delivery, this can also be visualized (dynamically). This is particularly advantageous with regard to packing applications, since the piece goods most times need to be stacked in one single preset orientation onto the piece good stack already located on the order pallet. In this context it can be quite relevant whether the piece good is orientated correctly, or stands upside down, because not every piece good has a homogenous weight distribution.

Additionally, the system can further comprise a voice-guidance system, which comprises an earphone and a microphone, preferably in terms of a headset.

The manipulation steps can be controlled additionally by the voice-guidance system (Pick-by-Voice) by means of voice. This concerns both instructions, which are received by the operator audibly, and also instructions (e.g. a confirmation), which is directed by the operator to the order-picking control in terms of voice.

According to a third aspect of the invention it is disclosed a method for monitoring and guiding a manual order-picking process, wherein a piece good is manually picked up by an operator at a source location, in accordance with an order-picking task, and is delivered to a target location comprising the steps of: assigning an order-picking task to the operator; visually or audibly communicating the task, preferable in terms of a sequence of manipulation steps, to the operator in the real space; picking-up, moving, and delivering the piece good in the real space by the operator; scanning the actual movement, preferably of the hands and/or the forearms, of the operator in the real space by means of a motion-sensor system; converting the movements, scanned in the real space, into image points or into at least one trajectory in a virtual space, which is modeled in accordance with the real space as a reference model and in which the source location is defined as a reference-source volume and the destination location is defined as a reference-destination volume; checking by comparing whether the trajectory matches a reference trajectory, wherein the reference trajectory fully corresponds to a motion sequence in the virtual space in accordance with the communicated task, or whether the image points are located initially within the reference-source volume and later in the reference-destination volume; and outputting an error notification, or a correction notification, to the operator, if the step of checking has resulted in a deviation between the trajectory and the reference trajectory, or if the step of checking results in that the image points are not located in the reference-source volume and/or in the reference-destination volume.

According to a fourth aspect of the invention it is disclosed a method for monitoring and guiding a manual order-picking process, wherein in accordance with an order-picking task a piece good is manually picked up by an operator at a source location and delivered to a target location in real space, the method comprising the steps of: assigning an order-picking task to the operator; visually, or audibly, communicating the order-picking task to the operator in the real space; picking-up, moving, and delivering the piece good in the real space by the operator; detecting the actual movement of the operator in the real space by means of a motion-sensor system; converting the detected movements into one of image points and at least one trajectory in a virtual space, which is modeled in accordance with the real space as a reference model and in which the source location is defined as a reference-source volume and the destination location is defined as a reference-destination volume, by means of a computing unit; checking, by means of the computing unit, by comparing: whether the at least one trajectory matches a reference trajectory, wherein the reference trajectory corresponds to a motion sequence in the virtual space in accordance with the communicated order-picking task, or whether the image points are located initially within the reference-source volume and later in the reference-destination volume; and outputting an error notification, or a correction notification, to the operator, if the step of checking has resulted in a deviation between the trajectory and the reference trajectory, or if the step of checking results in that the image points are not located in the reference-source volume and the reference-destination volume.

With the above-described method in accordance with the invention the motion of the operator is tracked (tracking) in the real space, which is mapped in terms of actual data into the virtual space and which is compared to nominal data there. The resolution is so good that it is possible to track the operator's hands alone. As soon as the operator does something unexpected, it is recognized and countermeasures can be initiated. The error rate can be drastically reduced in this manner. Therefore, acknowledgement keys or the like do not need to be actuated so that the operator can conduct the order-picking process completely undisturbed. The order-picking time is reduced. If a piece good is retrieved from the wrong source location, or is delivered to a wrong destination location, this is immediately registered (i.e., in real time) and communicated to the operator.

With a preferred embodiment at least one reference trajectory is calculated for each hand or forearm of the operator, which starts in the reference-source volume and ends in the reference-destination volume.

The order-picking control knows the pick-up location and the delivery location before the desired manipulation is conducted by the operator. Thus, it is possible to determine nominal motion sequences, which can be compared subsequently to actual motion sequences, in order to allow a determination of deviations.

Additionally, it is advantageous to further check whether the operator is picking up a correct number of piece goods in that a distance between the hands of the operator is determined and the same is compared to an integral multiple of one dimension of one of the piece goods with regard to plausibility, wherein several piece goods of one type only have to be moved simultaneously in accordance with the task.

The operator does not need to move the multiple piece goods individually for allowing determination of whether the right number of piece goods has been manipulated (counting check). The order-picking person can simultaneously move all of the to-be-manipulated piece goods, if he/she is able to, wherein the actually grabbed piece goods are counted during the motion. In this context, it is not required that the operator stops the motion at a preset time or preset location. In this sense the operator can work undisturbedly and conduct the motion continuously. The inventors have recognized that when multiple piece goods are grabbed most of the time both hands are used and have a constant distance relative to each other during the motion sequence, the distance can be clearly recognized during analysis of the trajectories. If piece goods of one sort only are manipulated the basic dimensions (such as height, width, depth) are kept within reasonable limits with regard to the possible combinations and can slip into the analysis of the distance between the hands. In this manner it can be determined rapidly whether the operator has grabbed the right number and the right piece goods.

According to a fifth aspect of the invention it is disclosed a method for manually determining a dimension of a piece good, wherein a system in accordance with the invention is used, wherein the hands, in particular the index finger, are provided with markers, the method comprising the steps of: selecting a basic-body shape of the piece good, wherein the basic-body shape is defined by a set of specific basic lengths; sequentially communicating the to-be-measured basic lengths to the operator; positioning the markers laterally to the piece good in the real world for determining each of the communicated basic lengths; and determining a distance between the markers in the virtual world, and assigning the so-determined distance to the to-be-measured basic length, respectively.

According to a sixth aspect of the invention it is disclosed a method for manually determining a dimension of a piece good in a storage and order-picking system, wherein an operator's hands, or index fingers, are provided with markers, the method comprising the steps of: selecting a basic body shape of the piece good, which is to be measured, wherein the basic body shape is defined by a set of specific basic lengths; sequentially communicating the to-be-measured basic lengths to the operator; positioning the markers laterally to the to-be-measured piece good in the real world for determining each of the communicated basic lengths; and determining a distance between the markers in the virtual world, which is modeled in accordance with the real space as a reference model, and assigning the so-determined distance to the to-be-measured basic length, respectively.

The operator does not need anything else but his/her hands for determining a length of a piece good. Any additional auxiliary tool can be omitted. The measuring of one of the piece goods happens rapidly since the hands only need to be in contact for a very short period of time.

Even more complex geometrical shapes such as a tetrahedron (pyramid) can be measured rapidly and easily. A selection of basic bodies can be displayed to the operator from which the operator can select the shape of the piece good, which is currently to be measured. As soon as one of the basic shapes is selected, it is automatically displayed to the operator, which lengths are to be measured. In this context, the indication preferably happens visually by representing the points in a marked manner at the selected basic shape.

Also the thumbs, besides the index fingers, can be additionally provided at least with one marker, wherein the index finger and the thumb of each hand are spread away from each other during the measuring process, preferably in a perpendicular manner.

In this case thumbs and index fingers span a plane which can be used for measuring the piece good. Additionally, angles can be indicated in a simple manner. Rotating and tilting the piece good, in order to measure each of the sides, is not necessarily required. The index fingers and thumbs do not necessarily need to be spread perpendicularly. Any arbitrary angle can be measured on the piece good by means of an arbitrary angle between the index finger and the thumb.

With another embodiment of the method the to-be-measured piece good is rotated about one of its axes of symmetry for determining a new basic length.

According to a seventh aspect of the invention it is disclosed a method for controlling a storage and order-picking system in accordance with the invention comprising the steps of: defining a set of gestures, which respectively correspond to one unique motion or rest position of at least one arm and/or at least one hand of the operator and which sufficiently distinguish from normal motions, respectively, in the context of desired manipulations of the piece good in the working area; generating reference gestures in the virtual world, wherein at least one working-area control instruction is assigned to each of the reference gestures; scanning the actual motion of the operator in the real world, and converting same into at least one corresponding trajectory in the virtual world; comparing the trajectory to the reference gestures; and executing the assigned working-area control instruction if the comparison results in a sufficient match.

According to an eighth aspect of the invention it is disclosed a method for controlling a storage and order-picking system, which comprises a work station arranged in a fixed working area in real space, comprising the steps of: defining a set of gestures, which respectively correspond to one unique motion, or rest position, of at least one of an arm and of at least one hand of an operator and which sufficiently distinguishes from normal motions, respectively, in the context of desired manipulations of a piece good in the working area; generating reference gestures in a virtual world, which is modeled in accordance with the real space as a reference model, wherein at least one working-area control instruction is assigned to each of the reference gestures; scanning the actual motion of the operator in the real world, and converting the scanned motion into at least one corresponding trajectory in the virtual world; comparing the trajectory to the reference gestures; and executing the assigned working-area control instruction if the comparison results in a sufficient match.

The operator can indicate to the order-picking control by means of hand motions only whether the operator has completed one of the partial manipulation steps, or whether the operator wants to begin with a new manipulation step. Acknowledgment keys, switches, light barriers, and the like can be omitted completely. A manipulation step can be conducted at a higher speed since the actuation of an acknowledgement key or the like, is omitted, in particular the paths associated therewith.

In particular, the operator can log in at a superordinate control unit as soon as the operator enters a working cell for the first time.

The operator can easily identify himself/herself to the order-picking control by a “Log-on” or registration gesture, the order-picking control preferably being implemented within the control unit by means of hardware and/or software. Each of the operators can have a personal (unambiguous) identification gesture. In this manner each motion detected within a working cell can be assigned unambiguously to one of the operators.

Further, it is advantageous to attach at least one marker to each of the operator's hands, and/or to each of the operator's forearms, before the operator enters the working cell.

In this constellation operators are allowed to enter the working cell without being recognized if they do not have markers with them. Thus, differentiation between active and inactive operators is easily possible.

With another preferred embodiment the operator, and in particular the markers, are permanently scanned for recognizing a log-in gesture.

Additionally, it is generally advantageous to conduct the respective steps in real time.

Thus, it is possible to intervene at any time in a correcting manner and to inquire at any time which of the persons is currently conducting a process within the storage and order-picking system, where the person is located, where the person has been located before, how efficient the person works, and the like.

Further, it is generally preferred to conduct a position calibration in a first step.

Position calibration is particularly advantageous for determining an absolute position, because in this case absolute positions can be determined even by means of the relative position-determining systems.

In particular, the trajectories of the operator are stored and are data-associated to information of such piece goods which have been moved by the operator during a (work)shift, wherein in particular a work period, a motion path, particularly in horizontal and vertical directions, and a weight of each moved piece good are considered.

In many countries statutory provisions consist for ergonomical reasons in that operators may not exceed fixedly preset limit values with regard to weights, which need to be lifted or pushed during one work shift. Up to now it was almost impossible to determine an overall weight, which has already been lifted or pushed by the operator during his/her work shift. In particular, it was almost impossible to reconstruct lifting motions. In this case, the present invention provides remedy. The properties (e.g. weight) of the piece goods are known. The motion of the operator is tracked. It is possible to immediately draw conclusions with regard to concise values.

With another advantageous embodiment a video image of the working area is generated additionally, to which the source volume, the target volume, the scanned hands, the scanned forearms, and/or the scanned operator is/are superimposed and subsequently displayed to the operator via a display device in real time.

### BRIEF DESCRIPTION OF THE DRAWINGS

It is clear that the above-mentioned and hereinafter still to be explained features cannot only be used in the respectively given combination but also in other combinations or alone, without departing from the scope of the present invention.

Embodiments of the invention are depicted in the drawings and will be explained below in further detail, wherein:

FIG. 1 shows a block diagram of a storage and order-picking system;

FIG. 2 shows a top view of a work station;

FIGS. 3A and 3B show a motion-sensor system having a position-determining system;

FIG. 4 shows a top view of another position-determining system;

FIG. 5 shows a side view of another position-determining system;

FIG. 6 shows a top view of an order pallet;

FIG. 7 shows a perspective view of an order pallet including an displayed stack of piece goods and a visualized target volume;

FIG. 8 shows a flow chart of a method for picking a piece good;

FIG. 9 shows a flow chart of a method for picking multiple piece goods from storage containers into order containers;

FIG. 10 shows a perspective view of a storage-container buffer;

FIG. 11 shows a flow chart of a method for checking counts and for measuring piece goods;

FIGS. 12a and 12b show perspective illustrations of a counting check during a transfer process;

FIGS. 13a to 13c shows a perspective view of a sequence of measuring processes;

FIG. 14 shows a table of piece-good characteristics;

FIG. 15 shows a table of employees;

FIG. 16 shows a flow chart of a log-in method;

FIG. 17 shows a perspective illustration of an operator picking in accordance with the principle “man-to-goods”; and

FIGS. 18 to 21 show perspective views of exemplary gestures of the operator, in order to control a work station.

### PREFERRED EMBODIMENTS OF THE INVENTION

During the following description of the figures identical elements, units, features, and the like will be designated by the same reference numerals.

The invention is used in the field of intralogistics and substantially concerns three aspects interacting with each other, namely i) order-picking guidance (in terms of an order-picking guidance system), ii) checking and monitoring employees (order-picking persons and operators), and iii) control of different components of a work station, or of an entire storage and order-picking system by means of gesture recognition.

The term “gesture recognition” is to be understood subsequently as an automatic recognition of gestures by means of an electronic data processing system (computer) which runs corresponding software. The gestures can be carried out by human beings (order-picking persons or operators). Gestures, which are recognized, are used for human-computer interaction. Each (rigid) posture and each (dynamic) body motion can represent a gesture in principle. A particular focus will be put below on the recognition of hand and arm gestures.

In the light of a human-computer interaction a gesture can be defined as a motion of the body, the motion containing information. For example, waving can represent a gesture. Pushing a button on a keyboard does not represent a gesture since the motion of a finger towards a key is not relevant. The only thing which counts in this example is the fact that the key is pressed. However, gestures are not exhausted in motions only, a gesture can also happen by means of a static (hand) posture. In order to detect the gesture, an (active) sensor technology can be attached directly to the operator's body. Alternatively (and supplementarily), the operator's gestures can also be observed by means of an external sensor technology (in a passive manner) only. The hereinafter still to be explained sensor systems are worn at the body of the operator, in particular on the hands and/or forearms. The operator can wear, for example, a data glove, arm gaiters, rings, ribbons, and the like. Alternatively systems can be used, which are guided manually. Systems including external sensor technology most of the time are represented by camera-aided systems. The cameras are used for generating images of the operator, which are subsequently analyzed by means of software for recognizing motions and postures of the operator.

During the actual recognition of gestures information of the sensor technology are used in algorithms which analyze the raw data and recognize gestures. In this context, algorithms for pattern recognition are used. The input data are often filtered, and pre-processed if necessary, in order to suppress noise and reduce data. Then gesture-relevant features are extracted, which are classified. In this context, for example, neural networks (artificial intelligence) are used.

With another passive approach of the general motion recognition (without gesture recognition), which will be described in more detail below, for example, a depth-sensor camera and a color camera including corresponding software are used, as exemplarily described in the document WO 2011/013079 A1 which is completely incorporated herewith by reference. For example, an infrared laser projects a regular pattern, similar to a night sky, into a (working) area, which is to be observed and within which the operator moves. The depth-sensor camera receives the reflected infrared light, for example, by means of a monochrome CMOS sensor. Hardware of the sensor compares an image, which is generated based on the reflected infrared rays, to a stored reference pattern. Additionally, an active stereotriangulation can calculate a so-called depth mask based on the differences. The stereotriangulation records two images at different perspectives, searches the points, which correspond to each other, and uses the different positions thereof within both of the images, in order to calculate the depth. Since the determination of corresponding points is generally different, in particular if a scene, which is offered, is completely unknown, illumination by means of a structured light pattern pays off. In principle, one camera is sufficient if a reflected pattern of a reference scene (e.g., chessboard at a distance of one meter) is known. A second camera can be implemented in terms of a RGB camera.

In this manner both the shape (depth) of the operator and the distance relative to the cameras can be determined. After a short scan also the shape (contour) of the operator can be detected and stored. Then, it is not disturbing if different objects move through the image, or are put between the operator and the camera.

With reference to FIG. 1 a storage and order-picking system 10 is shown, which can comprise a goods receipt WE, a goods issue WA, and/or a warehouse 12. Further, so-called “teach-in” stations 11 and separating stations 13 can be provided in the area of the goods receipt WE. A dimension (e.g. height, width, and depth) of a piece good can be measured at the “teach-in” station 11, in order to provide data to a superordinated order-control which are required for handling a corresponding piece good (e.g. storing, storage volume, retrieving, packing, etc.).

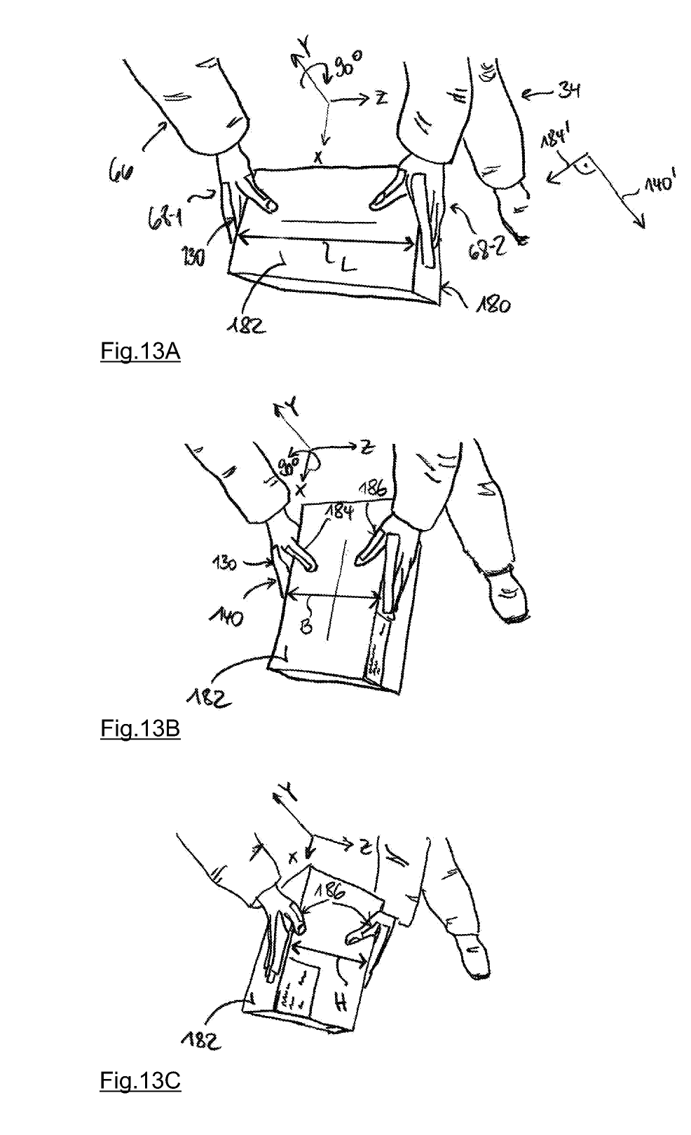

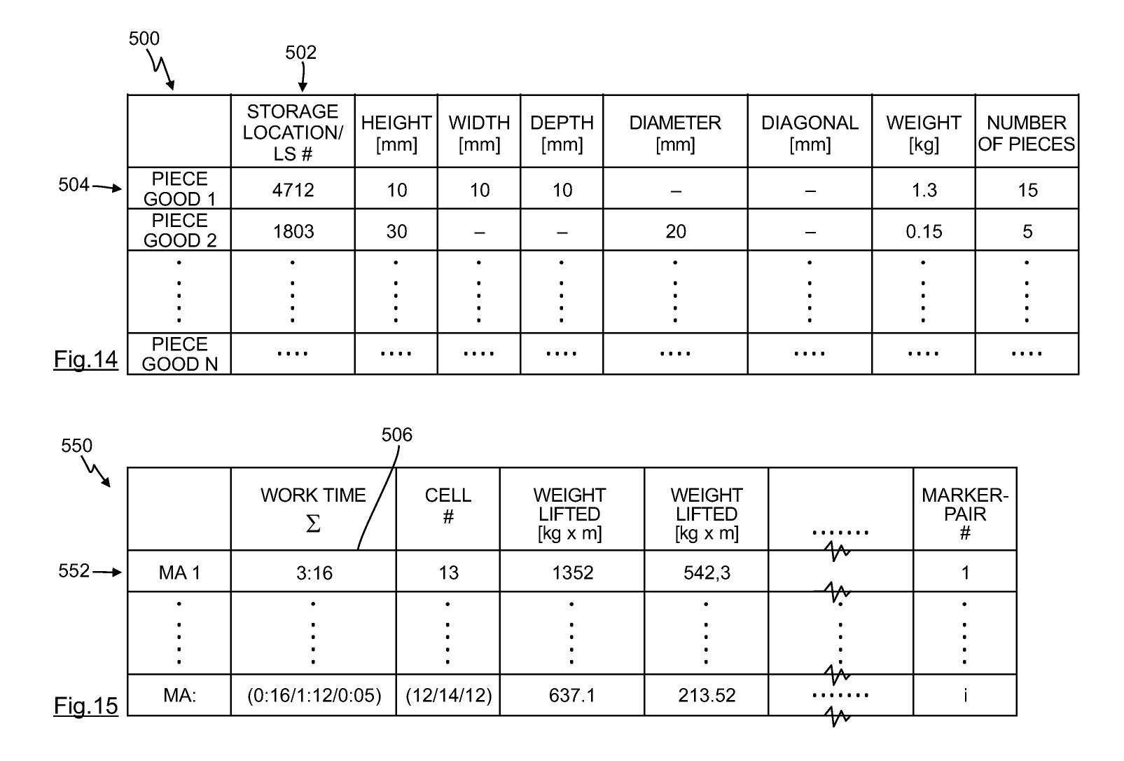

Basically, each component of the storage and order-picking system 10, which is involved in a material flow, can be connected through conveying systems, or conveyors 14, which are drivable in a bidirectional manner. The conveyors 14 are indicated by means of arrows in FIG. 1. The warehouse 12 can be connected to a sorting device 16 and other working stations 22, such as an order-picking station 18 or a packing station 20, via the conveyors 14. The control of the material flow is handled by a control unit 24 comprising a calculating unit 26. The control unit 24 can be realized in terms of a central host, or in terms of a computer which is distributed in a decentralized manner. The control unit 24 is operated by software, which takes over the order-picking control. The order-picking control exemplarily comprises a warehouse management, an order management, order-picking guidance strategies (such as Pick-by-Voice, Pick-by-Light, Pick-by-Vision or the like), a material management system, and/or the warehouse management. The warehouse management in turn can regulate a material flow as well as a storage-location management. Further, the order-picking control can comprise an interface management. The above-described functions are implemented mainly in terms of software and/or hardware. They can communicate to each other via one (or more) communication bus(es). The order management is responsible for distributing incoming picking orders to working stations 22, such as to the order-picking station 18, in order to be processed. In this context, factors such as work load, piece good range, path optimization, and the like are relevant. The order-picking control needs, amongst other things, information as exemplarily described with reference to the FIGS. 14 and 15, in order to fulfill such tasks.

Getting back to FIG. 1 the control unit 24 communicates in both directions relevant information through fixed lines, or wirelessly. In FIG. 1 motion signals 27 are exemplarily shown in terms of signal inputs to the control unit 24. Output signals are exemplarily shown in terms of control signals 28.

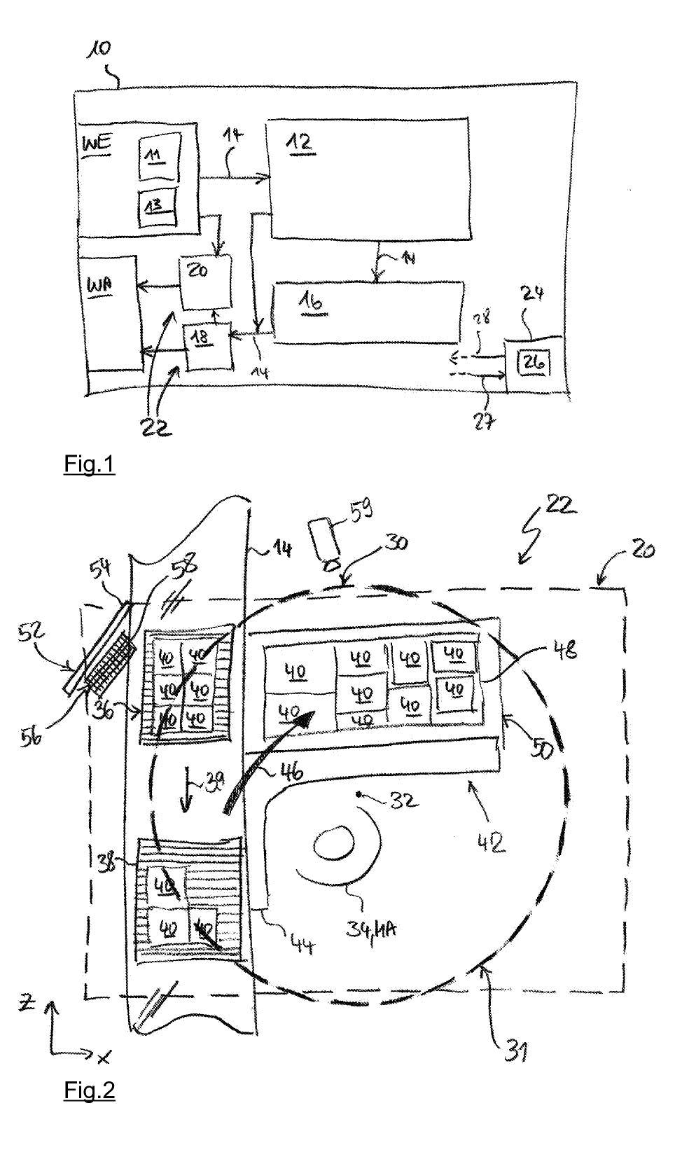

FIG. 2 shows a top view of a work station 22, which is here exemplarily represented by a packing station 20. The packing station 20 comprises a working area 30 which, in this case, corresponds to a cell 31. The cell 31 can be bigger than the working area 30, and therefore can include several working areas 30. The cell 31, or the working area 30 in this case, covers a volume, the base area of which is circular, as indicated in FIG. 2 by means of a dashed line. In FIG. 2 the cell 31 can be covered by a camera (not illustrated), which is positioned along an axis above the packing station 20, which extends perpendicularly to the drawing plane of FIG. 2 through a center point 32 of the working area. In the example of FIG. 2 the field of view of the camera, which is not depicted, corresponds to the working area 30.

An order-picking person, or an operator, 34 works in the working area 30 and is also designated as an employee MA below. The operator 34 substantially moves within the working area 30 for picking-up piece goods 40 from (storage) load supports 36, such as trays 38, and for retrieving the piece goods 40, which are conveyed into the working area 30 via a conveyor 14, as indicated by means of an arrow 39. In FIG. 2 the conveyor 14 is implemented in terms of a belt conveyor. It is clear that any arbitrary conveyor type (e.g. narrow-belt conveyor, roller conveyor, overhead conveyor, chain conveyor, etc.) can be used.

The operator 34 moves (manipulates) piece goods 40 at the packing station 20 from the trays 38 to, for example, an order pallet 48 or another target (container, card, tray, etc.) where the piece goods 40 are stacked on top of each other in accordance with a loading configuration which is calculated in advance. In this context, the operator 34 can be (ergonomically) assisted by a loading-aid device 42. In FIG. 2 the loading-aid device 42 is implemented in terms of an ergonomically shaped board 44, which is attached hip-high and comprises two legs, which are substantially orientated perpendicularly to each other and which connect the conveyor 14 to a packing frame 50. A longitudinal axis of the packing frame 50 preferably is oriented perpendicular to the longitudinal axis of the conveyor 14 so that the operator 34 does not need to reach too deep (direction Z) over the order pallet 48 while the piece goods 14 are packed.

The different manipulation steps are visually indicated to the operator 34, for example, via a display device 52. The display device 52 can be a screen 54, which can be equipped with an entering unit 56 in terms of a keyboard 58. It can be visually indicated to the operator 34 via the screen 54 how the piece good 40 looks like (label, dimension, color, etc.), which one of the piece goods the operator 34 is supposed to pick up from an offered tray 38 and which one is to be put on the order pallet 48. Further, it can be displayed to the operator 34 where the piece good 40, which is to be picked up, is located on the tray 38. This is particularly advantageous if the trays 38 are not loaded by one article type only, i.e. carry piece goods 40 of different types. Further, a target region on the order pallet can be displayed in 3D to the operator 34 so that the operator 34 merely pulls one of the to-be-packed piece goods 40 from the tray 38, pushes the same over the board 44 to the order pallet 48, as indicated by means of a (motion) arrow 46, and puts the same to a location, in accordance with a loading configuration calculated in advance, on the already existing stack of piece goods on the order pallet 48. In this context, the conveyor 14 is preferably arranged at a height so that the operator 34 does not need to lift the piece goods 40 during the removal. The order pallet 40 in turn can be positioned on a lifting device (not illustrated), in order to allow transfer of the order pallet 48 to a height (direction Y) so that a to-be-packed piece good 50 can be dropped into the packing frame 50. The packing station 20 can have a structure as described in the German patent application DE 10 2010 056 520, which was filed on Dec. 21, 2010.

As it will be described in more detail below, the present invention allows detection, for example, of the motion 46 (transfer of one piece good 40 from the tray 38 onto the order pallet 48) in real time, allows checking, and allows superimposing the motion 46 to the visual work instructions, which are displayed to the operator 34 through the screen 54. For example, nominal positions or nominal motions of the hands of the operator 34 can be presented. A superordinated intelligence such as the control unit 24 can then check, based on the detected and recognized motion 46, whether the motion 46 is conducted correctly.

At least the working area 30, which exists in the real world, is reproduced in a virtual (data) world including substantial components thereof (e.g., the convey- or 14, load support device 42, packing frame 50, and order pallet 48). If the real motion 46 is mapped into the virtual world, it can be determined easily by comparison whether the motion 46 has started at a preset location (source location) and has stopped at another preset location (target location). It is clear that a spatially and temporarily discrete comparison is already sufficient for this comparison, in order to allow the desired statements. Of course, motion sequences, i.e. the spatial position of an object dependent on time, i.e. trajectories, can be compared to each other as well.

Thus, additional information, besides the typical order-picking instructions such as the to-be-manipulated number of pieces and the type of piece goods, can be communicated to the operator 34 on the screen 54, the information increasing the quality and the speed of the order-picking process.

If the working area 30 is additionally recorded, for example, by means of a conventional (RGB) video camera, graphical symbols can be superimposed and displayed in this real image, the symbols corresponding to the expected source location, the target location (including orientation of the to-be-packed piece good 40), and/or the expected motion sequence. In this manner the operator 34 can recognize relatively simple whether a piece good 40 is picked up at the correct (source) location, whether the picked-up piece good 40 is correctly moved and/or orientated (e.g. by rotation), or whether the to-be-packed piece good 40 is correctly positioned on the already existing stack of piece goods on the order pallet 48.

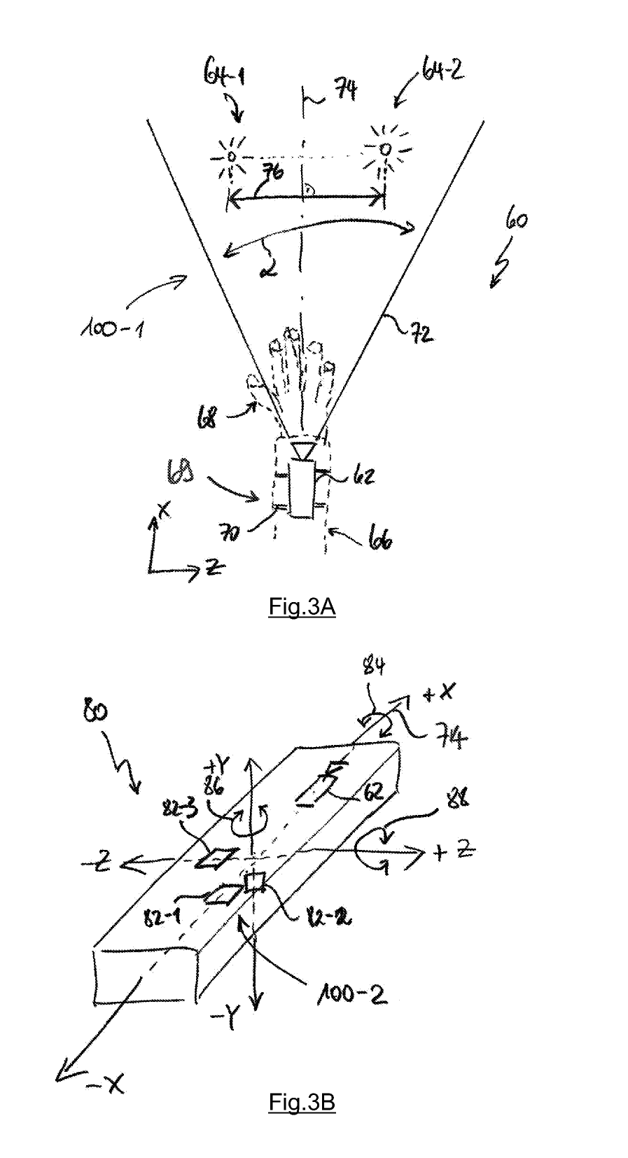

A first motion-sensor system 60 including a first absolute position-determining system 100-1 (FIG. 3A) and a second relative position-determining system 100-2 (FIG. 3B) is shown in FIGS. 3A and 3B which will be described below in common.

The motion-sensor system 60 of FIG. 3A comprises one camera 62 and two light sources 64-1 and 64-2 which can be operated, for example, in the infrared range, in order to not disturb the order-picking person 34. The camera 62 can be attached to a forearm 66, preferably along the (not shown) ell of the forearm 66, including a fixed orientation relative to the operator 34 so that the hand 68 can work in an undisturbed manner. The camera 62 can be fixed to a holding device 69, which can comprise (rubber) ribbons 70 so that the operator 34 can put on and take off the camera 62 as well as orientate the same along a preferred direction 74. The field of view of the camera 62 has a cone angle α, wherein the preferred direction 74 represents an axis of symmetry. An opening cone is designated by 72 in FIG. 3A.

The light sources 64-1 and 64-2 transmit rays, preferably isotropically. The light sources 64-1 and 64-2 are stationary arranged at a constant relative distance 76, preferably outside the working area 30. Of course, the relative distance between the light sources 64 and the camera 62 can be varied, because the operator 34 moves. However, the relative distance between the light sources 64 and the camera 62 is selected, if possible, such that the camera 62 has both of the light source 64-1 and 64-2 in its field of view at any time. It is clear that more than two light sources 64 can be utilized, which are arranged, in this case, along the virtual connection line between the light sources 64-1 and 64-2, preferably in accordance with a preset pattern.

If the camera 62 is directed towards the light sources 64, the camera 62 can see two “shining” points. Since the relative distance 76 is known, an absolute position determination can be performed by means of triangulation based on the distance of the light sources 64 in the image of the camera 62. Thus, in the present case the absolute position determination is achieved by triangulation.

Since it is possible that the camera 32 either does not “see” the light sources 64 at all or not in a sufficient number, another position-determining system 100-2 can be added to the position-determining system 100-1 of FIG. 3A, the other position-determining system 100-2 being part of a mobile sensor unit 80 which is fixedly carried by the operator 34.

The mobile sensor unit 80 of FIG. 3B can comprise the camera 62 of FIG. 3A. The second position-determining system 100-2 comprises several acceleration sensors 82. In the example of FIG. 3B three acceleration sensors 82-1, 82-2, and 82-3 are shown, wherein two acceleration sensors 82 would already be sufficient for a relative position determination. The acceleration sensors 82 are directed along the coordinate system of the mobile sensor unit 80, which in turn can be orientated along the preferred direction 64 of the camera 62.

A Cartesian coordinate system having base vectors X, Y, and Z is shown in FIG. 3B. Roll motion (cf. arrow 84) about the axis X can be detected by means of the acceleration sensor 82-1. Jaw motion (cf. arrow 86) about the axis Y can be detected by means of the sensor 82-2. Pitch motion (arrow 88) about the axis Z can be detected by means of the acceleration sensor 82-3.

It can be derived from the data delivered by the acceleration sensors 82 how the mobile sensor unit 80 is moved, and has been moved, within space, in particular because the acceleration sensors 82 can also detect motions—in terms of corresponding accelerations—along the base vectors. Hence, if it comes to a situation in which the camera 62 of the first position-determining system 100-1 does no longer “see” the light sources 64, even the absolute position of the mobile sensor unit 80 can be at least calculated, until the light sources 64 return into the field of view of the camera 62, based on the relative position which can be calculated due to the acceleration sensors 82.

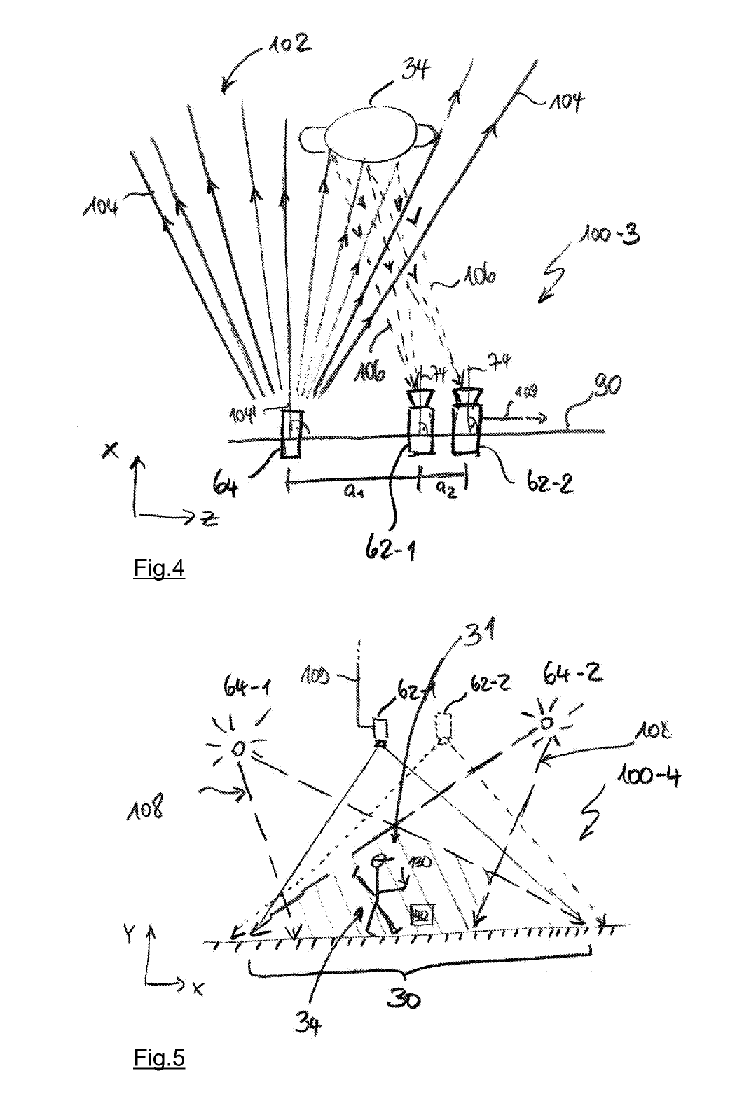

With reference to FIG. 4 a top view of an additional (relative) position-determining system 100-3 is shown. The third position-determining system 100-3 comprises one light source 64 and at least two cameras 62-1 and 62-2, all of which are arranged along a virtual straight line 90. The distances a1 and a2 between the light source 64 and the first camera 62-1 as well as between the first and second cameras 62-1 and 62-2 are known and cannot be changed. The light source 64 transmits an (anisotropic) light pattern 102 in terms of discretely and regularly arranged rays 104. The rays 104 preferably are equidistant, i.e. the points of the pattern 102, which are mapped onto a flat area, all have the same distance (namely in the horizontal and the vertical directions, preferably), if the flat area is orientated perpendicular relative to the preferred direction 104′ (i.e. perpendicular to the virtual line 90).

The separate rays 104 can be reflected by the operator 34 within the working area 30. Reflected rays 106 are detected by the cameras 62-1 and 62-2 and can be evaluated in a manner as described in the above-cited WO application. In this manner first depth information is gained from the curvature of the pattern 102 on the operator 34. Other depth information can be achieved due to stereoscopy so that a relative position of the operator 34 can be calculated. If additional aids such as models of a skeleton are used during the image processing a relative motion of the operator 34 can be calculated almost in real time (e.g., 300 ms), which is sufficient for being used either for motion recognition or motion check. The resolution is sufficiently high, in order to also allow at least an isolated recognition of the motion of the individual hands of the operator 34.

The third position-determining system 100-3 shown in FIG. 4 is passive in that the operator 34 does not need to carry sensors for allowing a (relative) position determination. Another passive (relative) position-determining system 100-4 is shown in FIG. 5 in a schematic side view.

The fourth position-determining system of FIG. 5 comprises at least one camera 62-1 and at least one light source 64. However, preferably a number of light sources 64 are utilized for sufficiently illuminating the working cell 31 so that sufficient reflections for evaluating the image of the camera(s) 62 are obtained from each location within the working cell 31, if possible. The working cell 31 is defined in FIG. 5 by the (spatial) area, which is commonly covered and illuminated by both of the light sources 64-1 and 64-2 as well as by the camera 62-1, as indicated by means of crosshatching. The size and the volume of the working cell 31 can be changed by the provision of additional cameras 62 and/or light sources 64. The (horizontally orientated) “shadow” of the working cell 31 can also be smaller than the working area 30.

With the fourth position-determining system 100-4 the light sources 64-1 and 64-2 emit isotropic rays 108, which in turn are in the infrared range and are reflected by markers 130, which can be worn by the order-picking person 34 on his/her body. The motions of the order-picking person 34 are detected via the reflected rays and are converted into a computer readable format so that they can be analyzed and transferred to 3D models (virtual world) generated in the computer. It goes without saying that also other frequencies than HZ can be used.

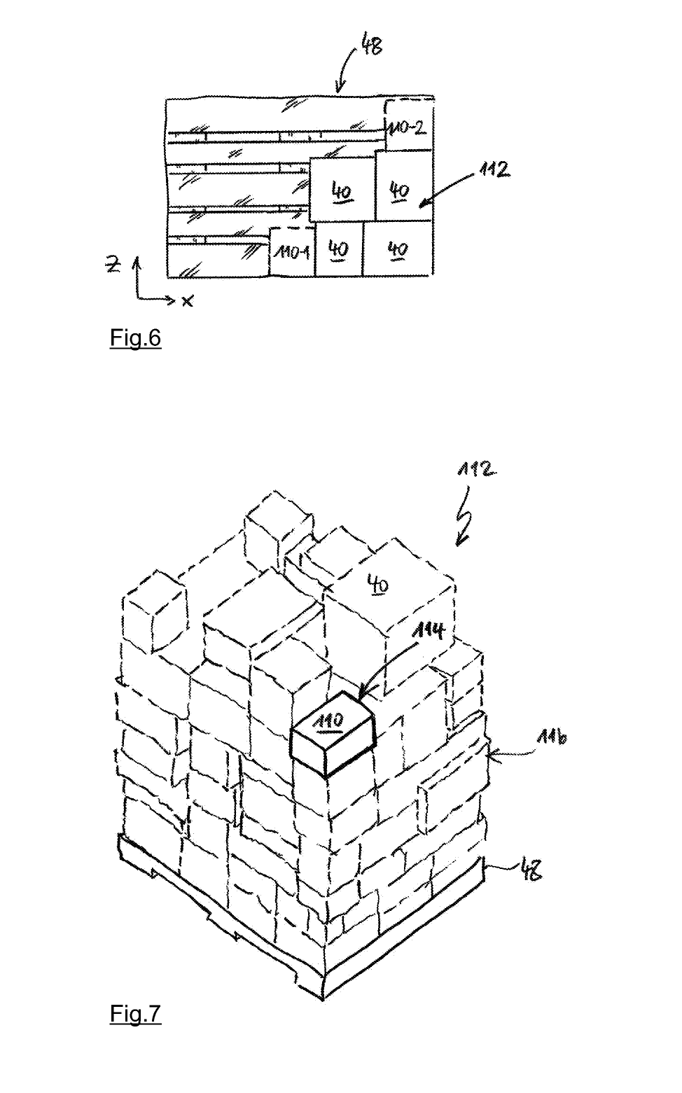

FIG. 6 shows a top view on the pallet 48 as seen by the operator 34 at the packing station 20 of FIG. 2, or like it is displayed to the operator 34 on the screen 54. In FIG. 6 already four (different) piece goods 40 have been loaded onto the order pallet 48. It is clear that instead of a pallet 48 also any other type of load support can be used such as a container, a carton, a tray, or the like. This applies to all load supports which can be used in the storage and order-picking system 10. Further, two possible positions 110-1 and 110-2 of a piece good 40 are shown in FIG. 6, which piece good is to be packed onto the order pallet 48 next. The possible positions 110-1 and 110-2 can be displayed in a superimposed manner on the screen so that the order-picking person 34 does not need to think about where to put the piece good 40 which is just to be packed.

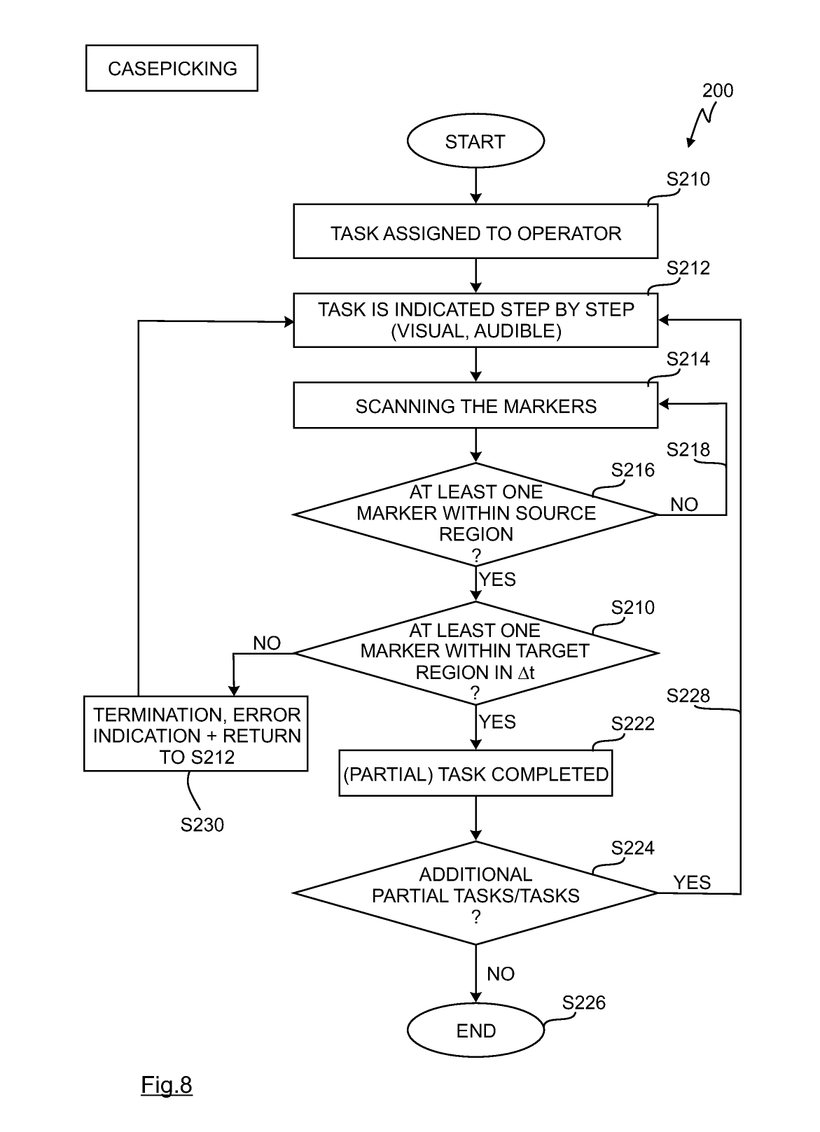

In FIG. 7 a perspective illustration of a similar situation as in FIG. 6 is shown. The illustration of FIG. 7 can be displayed to the operator 34 again via a display device 52 such as the screen 54 of FIG. 2. Alternatively, display devices such as a data goggle, a light pointer, or the like are possible, in order to display to the operator 34 a target volume 140 within a packing configuration 112. The packed stack 116 consisting of already packed piece goods 40 is indicated by means of dashed lines. Piece goods which are packed can be displayed on the screen 54, for example, in grey while the target volume 114 is illustrated in colors. Such a visual guidance assists the operator 34 in finding the possible packing position 110 without problems. This also applies with respect to the orientation of the to-be-packed piece good 40.

With reference to FIG. 8 a flow chart is shown representing a method 200 for picking piece goods 40.

In a first step S210 an (order-picking) task is assigned to the operator 34. The order-picking task can comprise a number of sequential manipulation steps such as the picking up of a piece good 40 from a source location, the moving of the piece good 40 to a target location, and the putting of the piece good 40 on the target location.

In a step S212 the task is visually and/or audibly (Pick-by-Voice) communicated to the operator 34. In a step S214 markers 130 are scanned at a scanning rate which can be selected freely. Dependent on whether a passive or an active sensor system is utilized, a marker 130 can also be represented by the operator 34, one or both hands 68, one or both forearms 66, a reflecting web, fixed reference points, a data glove having active sensors, an arm gaiter having active sensors, or the like.

In a step S216 it is checked during the picking or transferring of a piece good 40 whether at least one marker 130 such as the hand 68 of the order-picking person 34 is located within a source area. The source area corresponds to a source location or source volume where the picking up of a to-be-manipulated piece good 40 is to occur. For example, this can be a provision position of the trays 38 in FIG. 2. As soon as it is ensured that the operator 34 has grabbed the to-be-manipulated piece good 40, for example, by detecting and evaluating that the hand 68 is or was within the source area, it is inquired in a step S220 whether one of the markers has arrived within the target area. The arrival should happen preferably within a preset period of time Δt. If the to-be-manipulated piece good 40 does not arrive in the target area within the expected period of time Δt, the likelihood is relatively high that an error has occurred during the performance of the desired manipulation process. In this case the manipulation process can be terminated in a step S230. An error, which has occurred, can be displayed so that return to step S212 is possible.

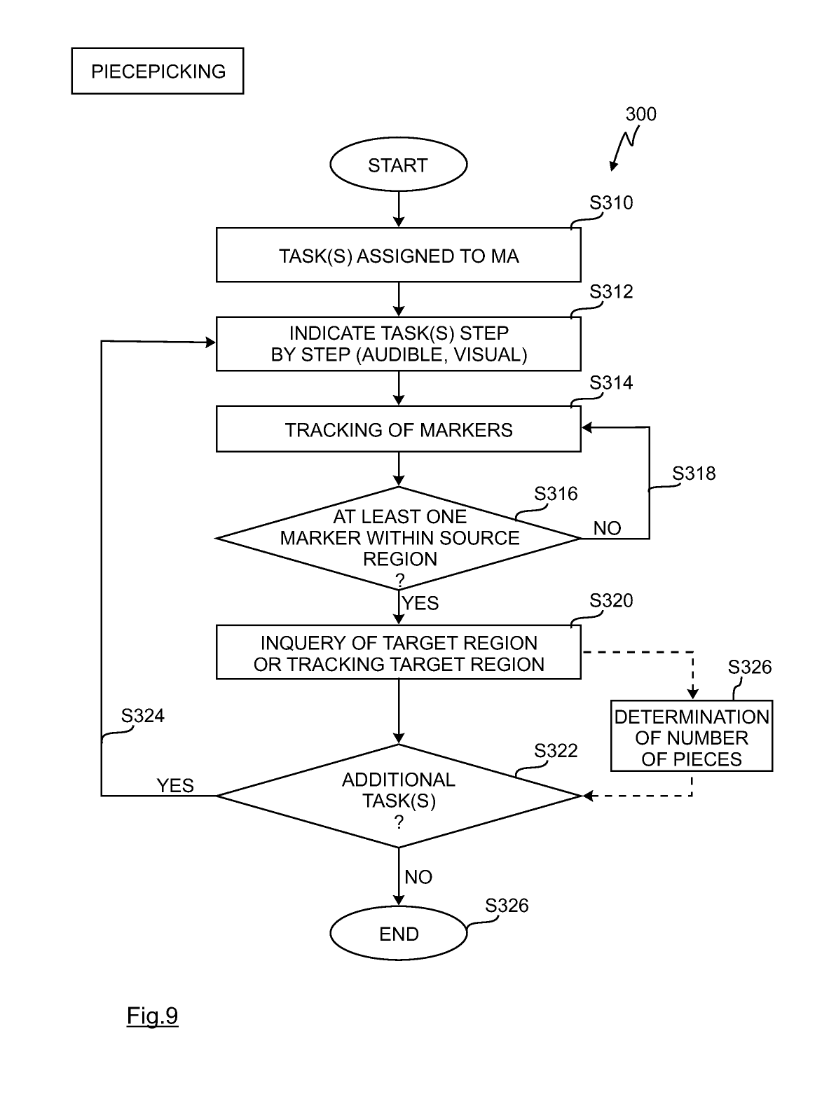

However, if the marker reaches the target area, preferably within the preset period of time Δt, the corresponding (partial) task is completed (cf. step S222). In another step S224 it can be inquired whether additional (partial) tasks exist. If another task exists, return to step S212 is possible in step S228. Otherwise, the method ends in step S226. Additionally, number of pieces can be determined as well, as it will be explained below with reference to FIG. 9.

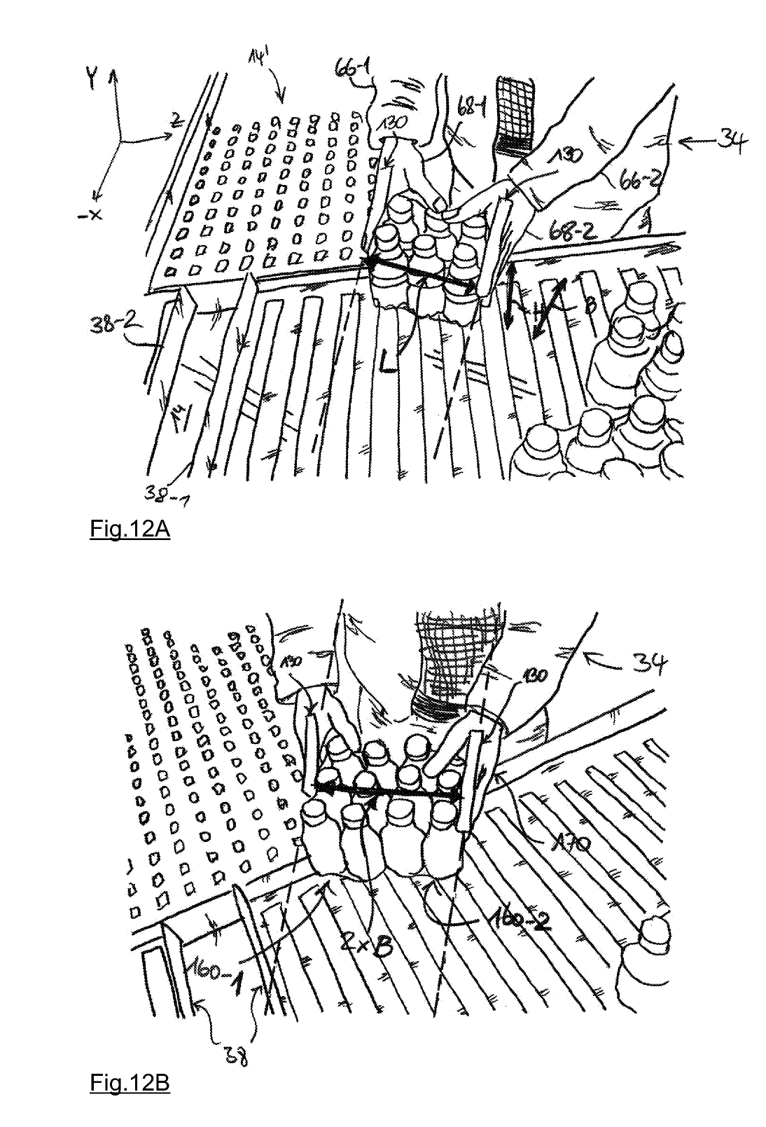

With reference to FIG. 9 a flow chart is shown which shows a method 300 for simultaneously picking a number of piece goods 40. Only as an auxiliary measure it is referred to the fact that the term “picking” is not only to be understood as the collecting of piece goods 40 in accordance with a (picking) order but also as, for example, transferring of piece goods 40, for example, from a first conveying system to a second conveying system, as will be described in more detail in the context of FIGS. 12A and 12B.

The method 300 shown in FIG. 1 is substantially structured identically to the method 200 of FIG. 8. In a first step S310 an employee (operator 34) is assigned to a task. In a step S312 it is audibly and/or visually communicated to the employee what is to be done within the framework of the task. This communication happens step by step, if necessary. In a step S314 the markers are scanned again (tracking), in order to determine in a step S316 when and if one of the markers is within the source area. As long as no markers are present in the source area, the scanning continues (cf. step S318).

If the marker(s) have been detected within the source area, in a step S320 it is again inquired when and if the marker(s) has reached the target area.

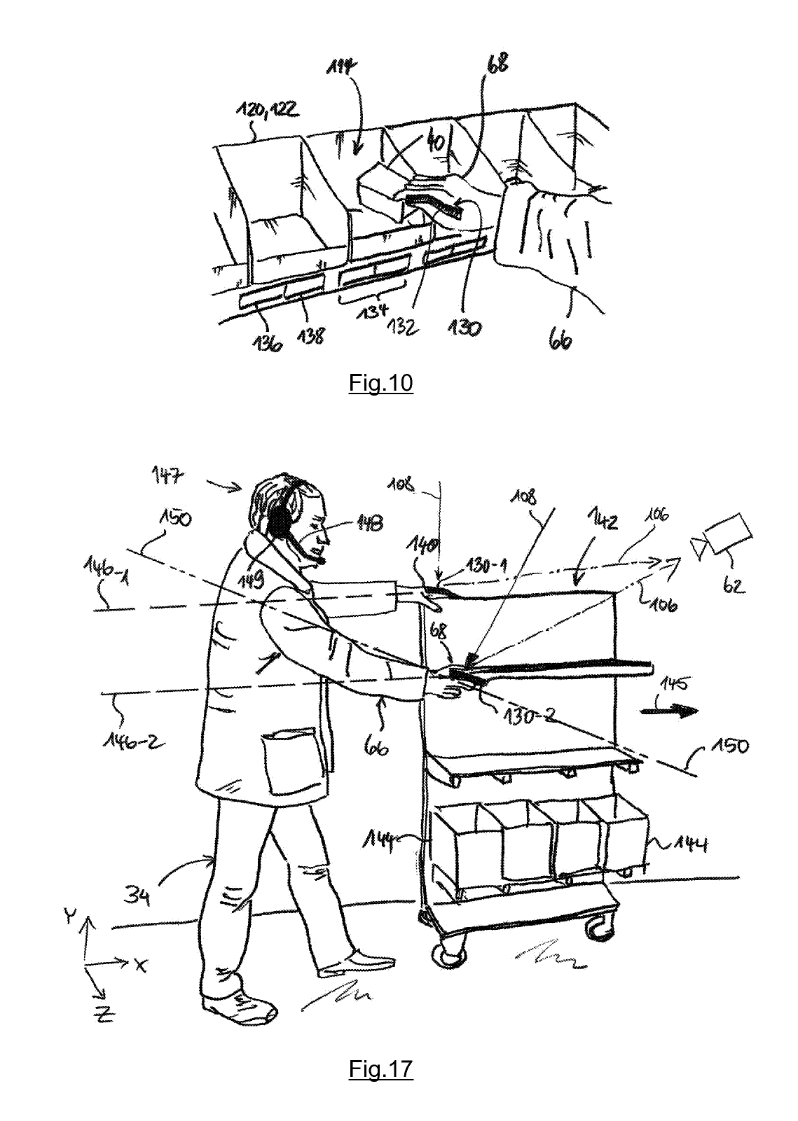

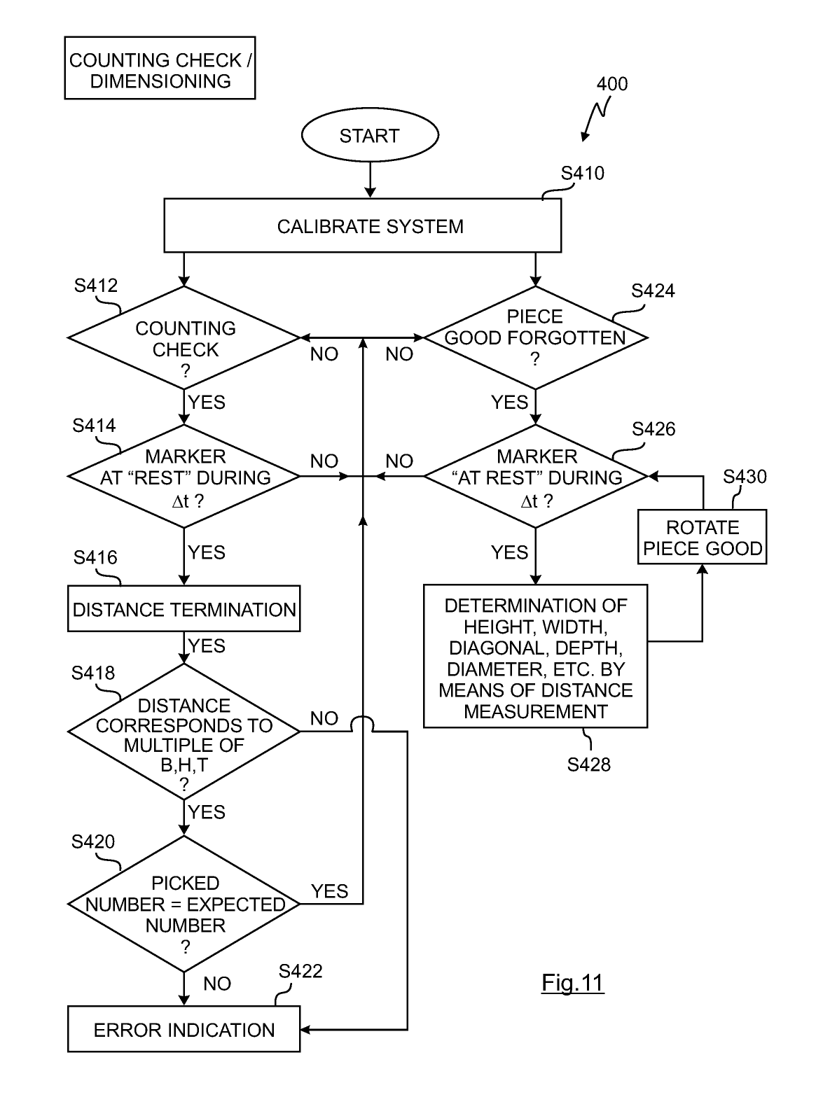

At the same time, in a step S326 determination of number of pieces can be conducted, which will be described in more detail in the context of FIG. 11, while the piece goods 40 move from the source area to the target area.

In a step S322 it can be inquired whether additional tasks need to be performed. If additional tasks need to be performed, one returns to step S312 in step S324. Otherwise, the method ends in step S326.

FIG. 10 shows a perspective view of a buffer of storage containers 120, or order containers 122, which are arranged exemplarily side by side, in the present case as a rack row. If the containers shown in FIG. 10 are order containers 122, then the volume of the order container 122 corresponds to the target volume 114. If the container is the storage container 120, the volume of the storage container 120 corresponds to the source volume.

FIG. 10 is operated by means of a passive motion-sensor system 60, as exemplarily shown in FIG. 4 or FIG. 5. The hand 68 of the operator 34 is provided with a reflecting strip 132 serving as marker 130. The strip 132 can be affixed, for example, to the operator 34 onto an outstretched index finger, preferably of each hand 68, or onto a data glove, or the like. The strip 132 can be made of a material which reflects the rays of the light sources 64 particularly well. In order to stay with the example of the above-described figures, the strip 132 could be an IR reflecting web. In this case, the corresponding IR camera 62 would receive reflected IR radiation of an IR light source 64. If the intensity and filter are selected in a suitable manner the camera 62 substantially sees only the reflecting strip 132 since the other objects within the working area 30 only reflect the IR radiation poorly compared to the stripes 132.

Further, a conventional Pick-by-Light order-picking guidance system is shown in FIG. 10, which comprises display units 134 including at least one location display 136 and a number-of-pieces display 138.

The flow chart of FIG. 11 shows a method 400 for conducting a counting check and measuring a piece good 40. In general, the motion-sensor system 60 can be calibrated in a first step, here in step S410. The calibration can be performed, for example, in that the operator 34 puts his/her marked hands 68 (e.g., cf. FIG. 10) within the working area 30 to the outside of an object, the dimensions of which are known and therefore can be used as a measuring body.

If a counting check is to be conducted (cf. inquiry S412) it is inquired in a step S414 at a freely selectable scanning rate whether the markers 130 are at “rest” during a period of time Δt. At “rest” means during an order-picking process, for example, that the distance between the hands is not changing for a longer time because the operator 34 simultaneously transfers multiple piece goods 40 by laterally surrounding a corresponding group of piece goods, as will be explained in more detail in the context of FIG. 12.

If the markers 130 do not have a fixed relative distance during a preset period of time, the piece goods 40 likely are not manipulated for the time being so that the counting check starts from the beginning.

However, if a relative distance is measured over a longer time this relative distance is the basis of the counting check in step S416 and is compared with an arbitrary multiple of the dimensions of the to-be-manipulated type of piece goods. If, for example, rectangular piece goods 40 are manipulated, the relative distance can be a multiple of the width, the height, and/or the depth of one piece good 40. Two piece goods (of one type only) can also be grabbed simultaneously so that the distance between the hands corresponds to a sum of a length and a width. However, since it is known how many piece goods are currently to be manipulated simultaneously, the amount of possible solutions is clear and can be compared rapidly.

If the manipulated number of the piece goods 40 corresponds to the expected number (cf. step S420), the counting check (S412) can start from the beginning. If a number of to-be-manipulated piece goods 40 is too big for being grabbed at once, the operator 34 can either indicate this so that the sum of correspondingly more manipulation processes is evaluated, or the order-picking control autonomously recognizes the necessity of dividing the manipulation process.

If the grabbed number does not correspond to the expected number an error is displayed in a step S422.

As an alternative to the counting check, a piece good 40 can also be measured, as it will be described in more detail in the context of the FIGS. 13A to 13C.

If a piece good 40 is to be measured, in a step S426 similar as in the step S414, it is checked whether the markers are at “rest” during a (shorter) period of time Δt, i.e. if they have an almost constant relative distance.

In this manner the height, width, diagonal, depth, the diameter, or the like can be determined in a step S428. Then, in a step 430 the piece good 40 is rotated, and a new side of the piece good 40 is measured in the same manner.

With reference to FIGS. 12A and 12B two examples of counting checks will be given below, as depicted in the left branch of the flow chart of FIG. 11.

FIG. 12A shows a perspective view of a work station 22, where the piece goods 40 are moved from trays 38, which are transported by a conveyor 14, onto another conveyor 14′ arranged perpendicularly thereto.

The index fingers of the order-picking person are respectively connected to an active marker 130, for example, to the mobile sensor unit 80, as shown in FIG. 3B. In order to conduct the counting check safely, the operator 34 has received the instruction to take the to-be-manipulated piece goods 40 (in this case a six-pack of drinking bottles) by both hands 68-1 and 68-2 at oppositely arranged sides. In this case, the longitudinal axis of the markers 130 are located almost completely in the planes of the oppositely arranged sides of the piece good 40. The distance of the longitudinal axes, which are indicated in FIG. 12A by means of dashed lines, corresponds to a lengh L of one single piece good 40. Since the distance between the hands 68-1 and 68-2 is almost not changed during transfer movement of the piece good 40 from the tray 38-1 towards the other conveyor 14-2, the distance determination can also be determined and checked during this moving process.

FIG. 12B shows a situation in which the operator 34 simultaneously grabs and moves two piece goods 40. In this context, the operator 34 grabs the piece goods 40 such that the distance between his/her hands corresponds to the double width B of the piece goods 40. This distance is detected and evaluated.

With reference to FIGS. 13A to 13C an exemplary course of a measuring process is shown in terms of three momentary images, as described in FIG. 11.

Also the thumbs 184 are provided with respectively one additional marker 186 additional to the markers 130 which are attached to the index fingers 140. In this context, again a mobile sensor unit 80 of FIG. 3 can be used. The order-picking person 34 can be instructed in advance to spread the index finger 140 and the thumb 184 in a preferably right angle, as indicated by means of the auxiliary arrows 184′ and 140′ in FIG. 13A, during measuring of a piece good 180 without dimension. The thumb 184 and the index finger 140 span a plane which can be used for evaluating the distances and thus for determining the dimensions of the piece good 180 without dimension. In this manner, for example, the orientations of external surfaces such as the top side 182 of the piece good 180 without dimension, or the angle, can be determined by applying the thumb 184 and the index finger 140 to the corresponding piece-good edge.

A length L is determined in FIG. 13A by the relative distance of the index fingers 140. Then, the piece good 180 without dimension is rotated about the axis Y for determining the width B, as shown in FIG. 13B. Another rotation by 90° about the axis X results in the orientation shown in FIG. 13C. In FIG. 13C the height H, or the depth T, is determined.

The piece good 180 without dimension, which is shown in FIGS. 13A to 13C, is rectangular. Different shapes (e.g., sphere, tetrahedron, etc.) can be determined in the same manner, wherein the order-picking person 34 preselects a shape category (e.g., sphere), which is already stored, and gets subsequently communicated length by the control unit 26a, which is to be measured (e.g. the diameter).

The method of measuring a piece good 180 without dimensions, as shown in the FIGS. 13A to 13C, can be further simplified if the piece good 180 is positioned during the measuring process on a surface (e.g., working table), which is fixedly defined in space. The working table can be stationary but also mobile. In the above-mentioned case it can be sufficient, for example, for a rectangular parallelepiped, if the stretched thumbs and index fingers of each hand are orientated along a diagonal of the top side 182, wherein the index fingers are applied along the respectively vertical corner edge. Based on the distance of the index fingers the length of the diagonal can be determined. Based on the distance of the thumbs relative to the working surface the height of the piece good 180 can be determined. Based on the geometry of the rectangular parallelepiped and the length of the diagonal the length and the width of the piece good 180 can be determined. Hence, in this case the dimensions of the rectangular piece good 180 can be determined by “applying the hands” one time. Similar is possible with regard to different geometries of the piece good 180.

In FIG. 14 a table 500 is shown, which represents a plurality of data sets 504 of different piece goods (1 to N) in a database, which is connected to the control unit 24. The data sets 504 can comprise a plurality of attributes 502 such as storage location, the height, width and depth, a diameter, a length of a diagonal, the weight, a number of pieces stored, and the like. The data sets 504 can be completed by the just described measuring method if, for example, the dimensions of the piece good 180 are not known. However, the data sets can also be used for the purpose of warehouse management (see storage location) and material management (number of pieces/inventory).

In FIG. 15 another table 550 including data sets 552 is shown. The data sets 552 represent protocols of each employee MA, or each operator, 34. Different information of the operators 34 can be stored in the data sets 552. In a data field 506 an overall working time can be stored. The cell 31 and the working station 22, in which the employee works or has worked (history), can be stored in another data field. It is clear that the data can be broken down correspondingly if a working cell or working station is changed. Further, an overall weight can be stored, which has been lifted by the operator 34 so far. For this purpose the weights of the piece goods are summed up and multiplied, if necessary, with the respective lift, wherein the lift is derived from the detected and evaluated motions, or positions. Of course, the amount of the lifted weights can be summed alone, in particular for exchanging the operator 34, if an allowable overall load (weight/day) is reached prematurely. The same applies to the weight of the piece goods, which have been pushed by the operator 34 during his/her work shift.

If several operators 34 work within the system 10, the markers 130 can be equipped with individualizing features so that an assignment of the marker(s) 130 to the respective operator 34 is possible. In this case also a marker number is stored.

The first data set 552 of the employee MA1 expresses that this employee has already been working for three hours and sixteen minutes in the working cell No. 13 and has lifted an overall weight of 1352 kg about one meter and has pushed an overall weight of 542.3 kg about one meter. The marker pair No. 1 is assigned to the employee MA1. The employee MA i has worked sixteen minutes in the working cell No. 12, one hour and twelve minutes in the working cell No. 14, and then again five minutes in the working cell No. 12. In this context, he/she has lifted an overall weight of 637.1 kg (about one meter) and pushed 213.52 kg about one meter. The marker pair having the number i is assigned to the employee MA i. Data generated in this manner can be used for manifold purposes (survey of handicapped people, ergonomical survey, health survey, anti-theft security, tool issue survey, tracking of work and break times, etc.)

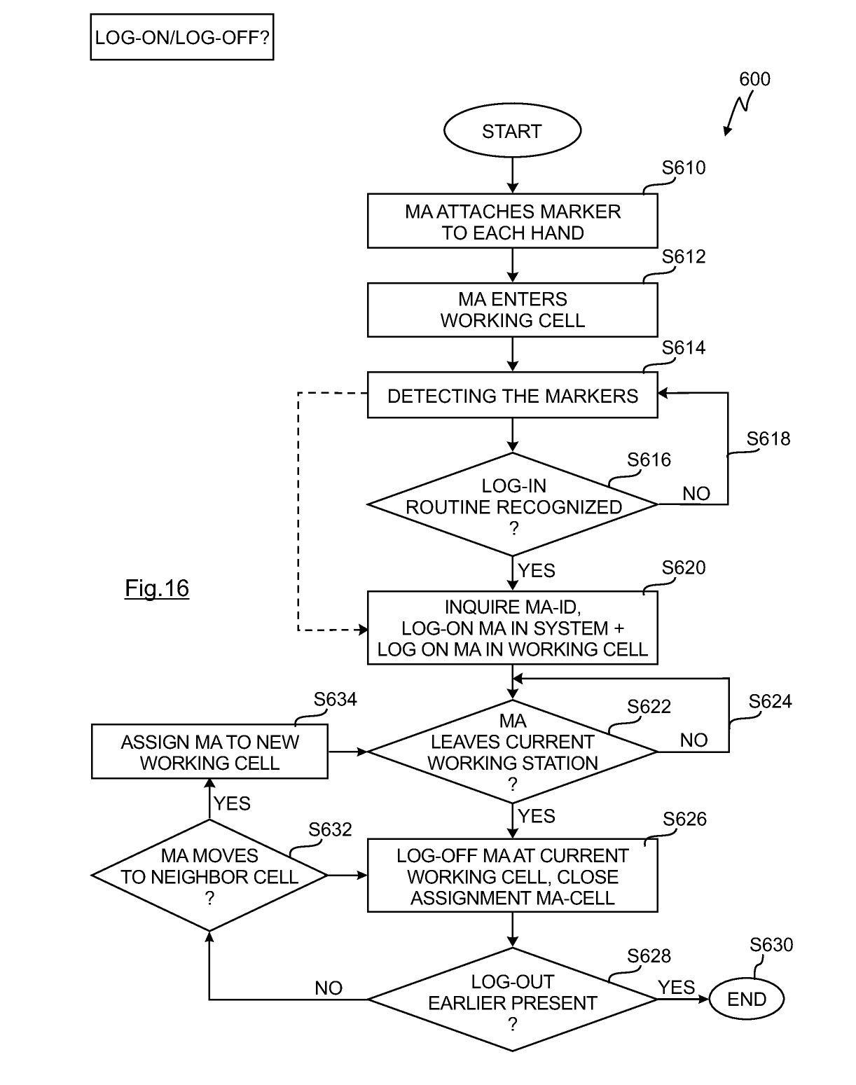

With reference to FIG. 16 a flow chart of a log-in method 600 is shown. In a first step S610 the employee MA attaches one or more markers 130, for example, one on each hand 68. In a step S612 the employee 34 enters one of the working cells 31 for working at one of the working stations 22. As soon as the markers 130 are detected in step S614, the recognition of a log-in routine can be initiated in step S616.

As soon as the markers 130 are detected in step S614, either a log-in sequence can be interrogated (step S616) or an employee-identification number can be retrieved automatically (step S620), thereby logging on the employee MA in the system (order-picking control) in the corresponding cell 31 or in the working area 30. If the employee MA leaves a current cell 31, this is detected by the inquiry of step S622, thereby logging off the employee MA at the current cell 31 in step S626 so that the assignment employee-cell is closed. As long as the employee 34 stays within the cell 31 (step S624), he/she is kept logged in at the current cell 31 and the assignment of this cell 31 is kept. Then, in a step S628 it can be inquired whether the employee MA has logged off, for example, by performing a log-out gesture within the current cell 31 by means of his/her hands. If he/she has performed a log-out gesture, the method ends in step S630. Otherwise it is inquired in step S632 whether the employee 34 has moved to an adjacent neighbor cell 31. In this case, the markers 130 of the employee 34 are detected in the neighbor cell 31 so that the employee 34 can be assigned to the new working cell 31 in step S634. Then, it is again inquired in cycles in step S622 whether the employee 34 has left the (new) current cell 31. The order-picking control has knowledge of the relative arrangement of the cells 31. Based on the motions of the employee MA it can be determined between which cells/working areas the MA has changed.

Thus, the motions of the employee 34 are not only detected and evaluated within the working area 30, or one single cell 31, but also in these cases where the employee 34 changes the areas 30/cells 31. Preferably the storage and order-picking system 10 comprises a plurality of adjacent cells 31. Of course, the cells 31 can also be arranged remotely to each other. In this manner it is possible to complete tasks extending over several cells 31 or greater distances within the storage and order-picking system (“man-to-goods”).

During picking in accordance with the principle “man-to-goods” it can happen that the operator 34 walks through the aisles of a warehouse 12 with an order-picking trolley 142 for processing simultaneously multiple orders in parallel (collecting). For this purpose the operator 34 takes a number of order containers 122 in the order-picking trolley 142. Such a situation is shown in the perspective illustration of FIG. 17. During an order-picking walk through, for example, rack aisles of the warehouse 12 the operator 34 can pass several cells 31, which are preferably arranged adjacent to each other or in an overlapping manner.

In FIG. 17 the operator 34 walks through the warehouse 12 with the order-picking trolley 142, as indicated by means of an arrow 145. A number of collecting containers 144, into which the operator 34 puts picked piece goods, are arranged on the order-picking trolley 142. The operator 34 has attached respectively one marker 130-1 and 130-2, for example, to the index fingers 140 of his/her hands 68. The operator 34 can be equipped additionally with a headset 147 comprising a microphone 148 and earphones 149. The operator 34 can communicate by means of voice with the order-picking (guidance) system via the headset 147 (Pick-by-Voice). In this case the to-be-taken number of pieces, the storage location, and the piece good is spoken (communicated) to the operator 34.

The motion of the operator 34, or his/her index fingers 140, is recorded by a camera 62 operated, for example, in the infrared range. Light sources 64, which are not depicted, transmit isotropic infrared rays 108 from the ceiling of the warehouse 12, which are reflected by the markers 130, as indicated by means of dash-dotted arrows 106. If the operator 34 walks through the warehouse 12, the index fingers 140 describe the motion tracks (trajectories) 146-1 and 146-2 as indicated by means of dashed lines. The motion tracks 146 represent points moving in space at the scanning rate of the camera 62.

Alternatively to the just described passive motion tracking also an active motion tracking can be performed by using, for example, mobile sensor units 80 as the markers 130. The direction, into which the index finger 140 is pointed, is indicated by means of a dashed line 150 at the right hand 68 of the operator 34. Also in this case motion tracks 146 can be recorded and evaluated.

With reference to the illustrations of FIGS. 18 to 21 different gestures will be described, which are recognized by the motion-sensor system 60 and evaluated by the calculating unit 26, in order to trigger specific procedures in the storage and order-picking system 10. The FIGS. 18 to 21 show perspective illustrations of exemplary gestures at the packing station 20 of FIG. 2.

In FIG. 18 the instruction “Lower order pallet” is shown. The hand 68 of the operator 34, and in particular the index finger 140 including the marker 130 attached thereto, is slightly inclined towards the flooring and remains in this position for a short period of time. The calculating unit 26 recognizes that the hand 68 is located outside of any possible target volume 114. The hand 68 is neither located in the region of one of the source volumes, but remains at rest outside these significant regions. Further the index finger 140, and thus also the marker 130, can be slightly directed downwardly. By comparing this (static) gesture to a plurality of fixedly defined and recorded reference gestures (including corresponding tolerances) the calculating unit 26 can recognize unambiguously the instruction “Lower order pallet”. In this case the calculating unit 26 generates a control instruction 28 directed to the lifting device within the packing frame 50 so that the lifting frame lowers.

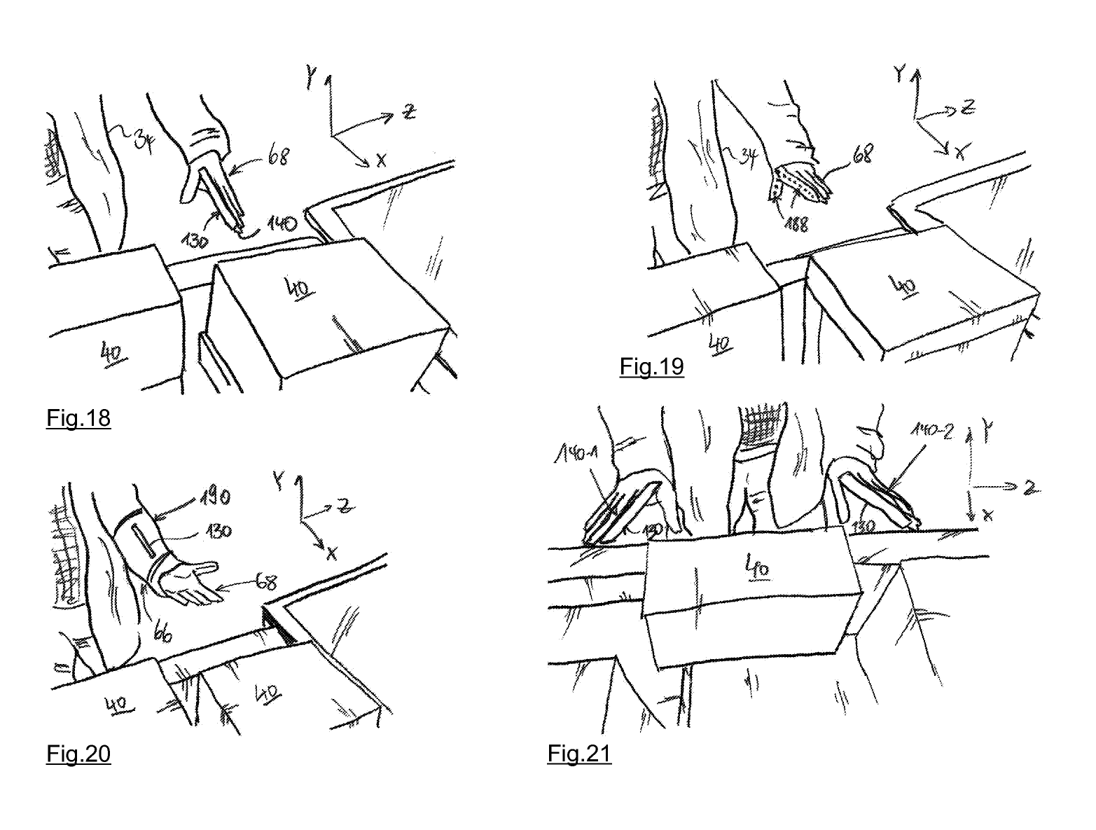

In FIG. 19 a different position-determining system 100 than in FIG. 18 is used. The operator 34 wears preferably on each hand 68 a glove, wherein a plurality of punctual reflectors 188 are arranged on the index finger and thumb thereof, which are respectively arranged along a straight line if the index finger 140 and thumb 184 are stretched out.

FIG. 19 serves for illustrating the instruction “Stop order pallet”, which can be performed immediately after the instruction “Lower order pallet” as shown in FIG. 18, in order to complete the lowering of the order pallet. With the gesture shown in FIG. 19 the thumb 184 and the index finger 140 are stretched out preferably at a right angle to each other. The thumb 184 extends along a vertical line. The index finger 140 extends along a horizontal line. Alternatively, the fingers could be orientated at first in parallel and then be moved into an angular position of substantially 90°.

FIG. 20 serves for illustrating the instruction “Lift order pallet”, wherein alternatively an arm gaiter 190 including markers 130 is used which recognizes an upward movement of the open palm of the hand 68 directed upwards. This case represents a dynamic gesture, wherein the forearm 66 initially hangs downwardly and then is moved up into a horizontal orientation.

The (static) gesture shown in FIG. 21, when the index fingers 140-1 and 140-2 are brought in a V-shaped position outside a region of the order pallet 48 and remain in this position for a (short) period of time Δt, serves for illustrating an acknowledgement process, i.e. completion of a manipulation process. In this case the operator 34 has moved his/her hands out of the danger area. The calculating unit 26 registers again that the hands 68 are located outside the source and target volumes, and registers additionally the static V-shaped gesture. If the order pallet 48 has been loaded completely, this gesture can result in a change of pallet. Otherwise, a change of tray can be initiated by this gesture so that a new tray 38, which is to be unloaded, is transported into the source region via the conveyor 14 (cf. FIG. 2) so that the operator 34 can immediately begin to process the next manipulation step, which is part of the processing of one order-picking order.

It is clear that the calculating unit 26 can evaluate and implement both (static) positions and dynamic motion sequences, in order to evaluate a situation (gesture).

With the above given description of the figures the orientation of the coordinate system has been chosen in general correspondence with the typical designations used in intralogistics so that the longitudinal direction of a rack is designated by X, the depth of the rack is designated by Z, and the (vertical) height of the rack is designated by Y. This applies analogously with regard to the system 10.

Further, identical parts and features have been designated by the same reference numerals. The disclosures included in the description can be transferred roughly onto identical parts and features having the same reference numerals. Position and orientation information (such as “above”, “below”, “lateral”, “longitudinal”, “transversal”, “horizontal”, “vertical”, or the like) are referring to the immediately described figure. If the position or orientation is changed, the information is to be transferred roughly to the new position and orientation.

It is clear that the gestures mentioned with reference to the FIGS. 18 to 21, of course, can be applied to any kind of control instructions. Switches, sensors, and keys can be eliminated completely by this kind of gestures. Light barriers and other security features, as nowadays used in the field of intralogistics in order to fulfill safety regulations, also become superfluous since the motions of the operator 34 are tracked in space in real time. The calculating unit 26 can also predict, for example, based on the direction of the just performed motion whether the operator 34 in (the near) future will move into a security area, and in this case will turn off a machine prematurely as a precaution. Thereby not only the use of sensor technology but also the wiring within the storage and order-picking system 10 is reduced. Tray or container changes can be initiated in an automated manner. Counting checks can be performed in an automated manner. Measuring objects can be conducted by simply applying hands. Operator guidance happens visually and in real time. Ergonomical aspects can be considered sufficiently by automatically tracking loads on the operator 34.

Further, it is clear that the “manipulation” explained above can mean different actions which are performed in the storage and order-picking system. In particular, “manipulation” comprises the performance of an order-picking task, i.e. the picking up, moving and delivering of piece goods from source locations to target locations in accordance with an order. However, it can also mean the measuring of a piece good, i.e. taking, holding and rotating the piece good while the operator's hands are in contact with the to-be-measured piece good.

Therefore, what we claim is:

1. A storage and order-picking system for storing and picking piece goods, comprising:
a manually operated work station arranged in a fixed working area, in which an operator manipulates the piece goods with his/her hands in a default manipulation manner, which is communicated to the operator visually, or audibly, wherein the operator moves the piece goods within the working area;
a motion-sensor system configured to detect the operators's motions within the working area of the work station, and to convert same into corresponding motion signals; and
a computing unit, which is connected to the motion-sensor system and which is configured to convert the motion signals into corresponding trajectories in a virtual space, which represents an image of the working area in real space, wherein the converted trajectories are compared to reference trajectories, or reference volumina, in the virtual space, which is modeled in accordance with the real space as a reference model, the computing unit being further configured to generate and output control signals, based on the comparison, which indicate a correct or wrong performance of the default manipulation manner to the operator.

2. The system of claim 1, which comprises at least one of a goods receipt, a goods issue, at least one warehouse, and several conveyors.

3. The system of claim 1, wherein the work station is one of a packing station, an order-picking station, and a teach-in station.

4. The system of claim 1, wherein the motion-sensor system comprises a position-determining system, which comprises at least one camera and at least two light sources, wherein the at least two light sources have a fixed distance to each other, wherein respectively one camera, or two light sources, are attached to the operator's hands, or forearms, and wherein the computing unit is configured to perform an absolute position determination of the hands, or forearms, within the working area based on an image of the two light sources recorded by the at least one camera.

5. The system of claim 4, further comprising a holding device, wherein the at least one camera, or the at least two light sources, are respectively attached to the holding device.

6. The system of claim 5, wherein the holding device is flexible and wearable by the operator during the performance of the manipulation of piece goods permanently, captively, and in a manner which allows to keep a fixed orientation of the at least one camera, or the at least two light sources, relative to the operator.

7. The system of claim 5, wherein the holding device is one of a glove, an arm gaiter, and a plurality of elastic ribbons.

8. The system of claim 1, wherein the motion-sensor system further comprises at least two acceleration sensors, which are orientated along different spatial directions spanning the working area, and which are configured to generate direction-dependent information, which is communicated to the computing unit, wherein the computing unit is configured to conduct a relative position determination of the operator within the working area based on the direction-dependent information.

9. The system of claim 1, wherein the motion-sensor system comprises a position-determining system, which comprises at least one stationary light source and at least one stationary camera, wherein each of the light sources is arranged to illuminate the working area by means of rays, wherein the at least one stationary camera is arranged so that the at least one stationary camera detects at least some of the rays, which are reflected by the operator and which are converted into reflection signals by the at least one stationary camera, wherein the computing unit is configured to conduct a relative position determination of the operator within the working area based on the reflection signals.

10. The system of claim 9, wherein the position-determining system further comprises markers, wherein each hand, or each forearm, of the operator is connected in a removable manner to one of the markers in an unchangeable default orientation relative to the operator, and wherein the at least one stationary light source emits homogeneous rays at a preselected wavelength into the working area, which are not reflected by the operator, the piece good, and the working station, wherein the one of the markers is formed of a material reflecting the preselected wavelength better than the operator.

11. The system of claim 10, wherein the markers include longitudinal flexible strips, which are attachable to at least one of an ell, a thumb, and an index finger of the operator, or to grid-like arranged points.

12. The system of claim 9, wherein the at least one stationary light source of the position-determining system emits a plurality of separate rays discretely into the working area in a predefined pattern, wherein at least two stationary cameras are provided, which are arranged in common with the at least one stationary light source along a straight line so that the at least two stationary cameras detect at least some of the separate rays, which are reflected by the operator, and convert the reflected rays into reflection signals, wherein the computing unit is configured to conduct a relative position determination of the hands, or forearms, within the working area based on the reflection signals.

13. The system of claim 12, wherein the at least two stationary cameras are operated in different frequency ranges.

14. The system of claim 1, further comprising a display device receiving the control signals of the computing unit and communicating the correct or wrong performance of the default manipulation manner in real time to the operator.

15. The system of claim 14, further comprising a video camera configured and arranged to generate a real image of the working area, wherein the computing unit is configured to generate image signals in real time and to transmit the image signals to the display device, which is configured to superimpose at least one of a source volume, a target volume, the hands, or forearms, of the operator, and work instructions to the real image.

16. The system of claim 1, further comprising a voice-guidance system, which comprises an earphone and a microphone.

17. A method for monitoring and guiding a manual order-picking process, wherein in accordance with an order-picking task a piece good is manually picked up by an operator at a source location and delivered to a target location in real space, the method comprising the steps of:
assigning an order-picking task to the operator;
visually, or audibly, communicating the order-picking task to the operator in the real space;
picking-up, moving, and delivering the piece good in the real space by the operator;
detecting the actual movement of the operator in the real space by means of a motion-sensor system;
converting the detected movements into one of image points and at least one trajectory in a virtual space, which is modeled in accordance with the real space as a reference model and in which the source location is defined as a reference-source volume and the destination location is defined as a reference-destination volume, by means of a computing unit;
checking, by means of the computing unit, by comparing:
whether the at least one trajectory matches a reference trajectory, wherein the reference trajectory corresponds to a motion sequence in the virtual space in accordance with the communicated order-picking task, or
whether the image points are located initially within the reference-source volume and later in the reference-destination volume; and
outputting an error notification, or a correction notification, to the operator, if the step of checking has resulted in a deviation between the trajectory and the reference trajectory, or if the step of checking results in that the image points are not located in the reference-source volume and the reference-destination volume.

18. The method of claim 17, wherein the order-picking task is communicated as a sequence of manipulation steps.

19. The method of claim 17, wherein the step of detecting an actual movement comprises detecting movement of at least one of the hands and the forearms of the operator.

20. The method of claim 17, wherein at least one reference trajectory is calculated by the computing unit for one of each hand and each forearm of the operator, wherein the reference trajectory starts in the reference-source volume and ends in the reference-destination volume.

21. The method of claim 17, wherein it is additionally checked whether the operator has picked up a correct number of piece goods by determining a distance between the hands of the operator and by comparing the determined distance to an integral multiple of one dimension of the piece good with regard to plausibility, if several ones of the piece good have to be moved simultaneously in accordance with the order-picking task.

22. A method for manually determining a dimension of a piece good in a storage and order-picking system, wherein an operator's hands, or index fingers, are provided with markers, the method comprising the steps of:
selecting a basic body shape of the piece good, which is to be measured, wherein the basic body shape is defined by a set of specific basic lengths;
sequentially communicating the to-be-measured basic lengths to the operator;
positioning the markers laterally to the to-be-measured piece good in the real world for determining each of the communicated basic lengths; and
determining a distance between the markers in the virtual world, which is modeled in accordance with the real space as a reference model, and assigning the so-determined distance to the to-be-measured basic length, respectively.

23. The method of claim 22, wherein also the thumbs, besides the index fingers, are respectively provided with at least with one marker, wherein the index finger and the thumb of each of the operator's hands are spread away from each other during the measuring process.

24. The method of claim 22, wherein the to-be-measured piece good is rotated about one of its axes of symmetry for determining another one of the basic lengths.

25. A method for controlling a storage and order-picking system, which comprises a work station arranged in a fixed working area in real space, comprising the steps of:
defining a set of gestures, which respectively correspond to one unique motion, or rest position, of at least one of an arm and of at least one hand of an operator and which sufficiently distinguishes from normal motions, respectively, in the context of desired manipulations of a piece good in the working area;
generating reference gestures in a virtual world, which is modeled in accordance with the real space as a reference model, wherein at least one working-area control instruction is assigned to each of the reference gestures;
scanning the actual motion of the operator in the real world, and converting the scanned motion into at least one corresponding trajectory in the virtual world;
comparing the trajectory to the reference gestures; and
executing the assigned working-area control instruction if the comparison results in a sufficient match.

26. The method of claim 25, wherein the operator logs-on at a superordinated control unit as soon as the operator enters a working cell for the first time.

27. The method of claim 26, wherein the operator attaches at least one marker to at least one of each hand and each forearm before the operator enters the working cell.

28. The method of claim 27, wherein the operator and the markers are permanently scanned in order to recognize a log-on gesture.

29. The method of claim 25, wherein the steps are executed in real time.

30. The method of claim 25, wherein in a first step a position calibration is conducted.

31. The method of claim 25, wherein the trajectories of the operator are stored and are associated to information of such piece goods which have been moved by the operator during a work shift, wherein at least one of a working period, a motion path in horizontal and vertical directions, and a weight of each moved piece good are considered.

32. The method of claim 25, wherein a video image of the working area is generated additionally, to which at least one of a source volume, a target volume, a scanned hands, a scanned forearms, and a scanned operator is superimposed and subsequently displayed to the operator via a display device in real time.
